(19) United States
(12) Patent Application Publication
(10) Pub. No.: US 2026/0226288 A1
(43) Pub. Date: Aug. 6, 2026

(54) NON-FLUORINATED ANTI-FINGERPRINT COATINGS

(71) Applicant: Henkel AG & Co. KGaA, Duesseldorf (DE)

(72) Inventors: Bong June Zhang, Newtown, MA (US); Nikhil Puranik, Burlington, MA (US); Fouad Salhi, Farmington, CT (US)

(21) Appl. No.: 19/468,497

(22) Filed: Feb. 3, 2026

Related U.S. Application Data
(63) Continuation-in-part of application No. PCT/US2024/021937, filed on Mar. 28, 2024.
(60) Provisional application No. 63/492,737, filed on Mar. 28, 2023.

(51) Int. Cl. C09D 5/16; C08G 77/12; C08G 77/18; C08G 77/20; C08G 77/28; C08K 5/5415; C08K 5/5419; C09D 7/63; C09D 183/06; C09D 183/08

(52) U.S. Cl. CPC C09D 5/1675; C08G 77/12; C08G 77/18; C08G 77/20; C08G 77/28; C09D 7/63; C09D 183/06; C09D 183/08; C08K 5/5415; C08K 5/5419

(57) ABSTRACT

Compositions (e.g., coatings) comprising a fingerprint inhibition material, and related articles, methods, and kits, are generally described. In certain embodiments, the coating comprises a fingerprint inhibition material that is configured to mitigate, inhibit, and/or prevent the appearance of fingerprints on a surface on which the coating is disposed. The fingerprint inhibition properties of the coating (e.g., anti-fingerprint coating) may be provided, in certain embodiments, by a silane compound comprising a polysiloxane that lowers the surface energy of the surface on which the coating is disposed and renders the coating hydrophobic and/or oleophobic. In addition to providing anti-fingerprint properties, the coating may be chemically inert, mechanically robust, optically transparent, and/or lubricious, in accordance with certain embodiments.

### TECHNICAL FIELD

Compositions (e.g., coatings) comprising a fingerprint inhibition material, and related articles, methods, and kits, are generally described.

### BACKGROUND

Anti-fingerprint coatings are used to inhibit the appearance of fingerprints on surfaces on which the coatings are disposed. Conventional anti-fingerprint materials used in coatings comprise fluorinated components that present toxicity and bioaccumulation issues that limit large-scale applications of the materials.

Accordingly, improved compositions, and related articles, methods, and kits, are necessary.

### SUMMARY

Compositions (e.g., coatings) comprising a fingerprint inhibition material, and related articles, methods, and kits, are generally described. The subject matter of the present invention involves, in some cases, interrelated products, alternative solutions to a particular problem, and/or a plurality of different uses of one or more systems and/or articles.

According to certain embodiments, a composition is described, the composition comprising a fingerprint inhibition material comprising a silane compound, the silane compound comprising a polysiloxane, wherein the fingerprint inhibition material is non-fluorinated, and wherein a water contact angle of the composition is greater than or equal to 95°.

In some embodiments, a composition is described, the composition comprising a fingerprint inhibition material comprising a silane compound, the silane compound comprising a polysiloxane and an ether or a thioether, wherein the fingerprint inhibition material is non-fluorinated.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows, according to certain embodiments, a schematic diagram of an exemplary article;

FIG. 2 shows, according to certain embodiments, a schematic diagram of an exemplary method of coating a substrate;

FIG. 3A shows, according to certain embodiments, the water contact angles of TMS Di-10, TMS Di-50, and TMS Di-400 before and after 3,000 eraser linear abrasion cycles;

FIG. 3B shows, according to certain embodiments, the diiodomethane contact angles of TMS Di-10, TMS Di-50, and TMS Di-400 before and after 3,000 eraser linear abrasion cycles;

FIG. 4 shows, according to certain embodiments, the molecular weight distribution of the reaction product of TMS Di-10 and dibutyltin dilaurate (DBTDL) as compared to TMS Di-10;

FIG. 5A shows, according to certain embodiments, the water contact angles of the reaction product of TMS Di-10 and DBTDL as compared to TMS Di-10 before and after 3,000 eraser linear abrasion cycles;

FIG. 5B shows, according to certain embodiments, the diiodomethane contact angles of the reaction product of TMS Di-10 and DBTDL as compared to TMS Di-10 before and after 3,000 eraser linear abrasion cycles;

FIG. 6A shows, according to certain embodiments, the water contact angles of the reaction product of TMS-Di 10 and DBTDL in a 90:10 weight ratio as compared to TMS Di-10 before and after 3,000 eraser linear abrasion cycles;

FIG. 6B shows, according to certain embodiments, the diiodomethane contact angles of the reaction product of TMD-Di 10 and DBTDL in a 90:10 weight ratio as compared to TMS Di-10 before and after 3,000 eraser linear abrasion cycles;

FIGS. 7A-7B show, according to certain embodiments, schematic representations of the synthesis of silane compounds comprising a thioether;

FIG. 8A shows, according to certain embodiments, the coefficient of friction (CoF) and color difference (AE) of various compositions;

FIG. 8B shows, according to certain embodiments, the water contact angles of various compositions before and after 3,000 abrasion cycles;

FIG. 8C shows, according to certain embodiments, the diiodomethane contact angles of various compositions before and after 3,000 linear abrasion cycles;

FIG. 9A shows, according to certain embodiments, the initial water and diiodomethane contact angles of various compositions comprising a silane compound;

FIG. 9B shows, according to certain embodiments, the water and diiodomethane contact angles of various compositions comprising a silane compound after 5,000 linear abrasion cycles;

FIG. 10A shows, according to certain embodiments, the initial water contact angle of a composition comprising a silane compound;

FIG. 10B shows, according to certain embodiments, the water contact angle of a composition comprising a silane compound after 5,000 linear abrasion cycles;

FIG. 11A shows, according to certain embodiments, the initial diiodomethane contact angle of a composition comprising a silane compound; and

FIG. 11B shows, according to certain embodiments, the diiodomethane contact angle of a composition comprising a silane compound after 5,000 linear abrasion cycles.

### DETAILED DESCRIPTION

Compositions (e.g., coatings) comprising a fingerprint inhibition material, and related articles, methods, and kits, are generally described. In certain embodiments, the coating comprises a fingerprint inhibition material that is configured to mitigate, inhibit, and/or prevent the appearance of fingerprints on a surface on which the coating is disposed. The fingerprint inhibition properties of the coating (e.g., anti-fingerprint coating) may be provided, in certain embodiments, by a silane compound comprising a polysiloxane that lowers the surface energy of the surface on which the coating is disposed and renders the coating hydrophobic and/or oleophobic. In addition to providing anti-fingerprint properties, the coating may be chemically inert, mechanically robust, optically transparent, and/or lubricious, in accordance with certain embodiments.

Advantageously, the compositions (e.g., coatings), articles, methods, and kits described herein may have beneficial properties as compared to conventional coatings and related methods. In some embodiments, for example, the coating is non-fluorinated, thereby obviating issues related to toxicity and/or bioaccumulation that accompany conventional coatings comprising anti-fingerprint materials that include fluorinated components. Furthermore, conventional coatings comprising fluorinated components also utilize fluorinated solvents for synthesis and/or processing. The non-fluorinated coatings described herein advantageously avoid the use of such fluorinated solvents, therefore decreasing fluorinated greenhouse gas emissions.

According to some embodiments, the silane compound comprises a polysiloxane (e.g., a repeating unit of ((R)₂—Si—O)). In certain embodiments, at least a portion of the silane compound may be functionalized with one or more hydrolysable moieties. The hydrolysable moieties may, in certain embodiments, be reacted with a hydrolysis agent to provide a hydrolysate of the silane compound. The hydrolysate of the silane compound may have improved durability, in some embodiments, as compared to an unhydrolyzed silane compound that is otherwise equivalent. According to some embodiments, the silane compound may be hydrolyzed prior to, during, and/or after disposing the composition comprising the silane compound onto at least a portion of at least one surface of a substrate, as explained herein in greater detail. In certain embodiments, the hydrolysate of the silane compound may exhibit enhanced adhesion to a substrate as compared to an unhydrolyzed silane compound that is otherwise equivalent.

In certain embodiments, the silane compound comprises an ether (e.g., a R—O—R moiety) or a thioether (e.g., a R—S—R moiety). The ether and/or the thioether may, in some embodiments, comprise a long alkyl chain that advantageously provides the silane compound with an increased hydrophobicity as compared to a silane compound that does not comprise the long alkyl chain but is otherwise equivalent.

According to some embodiments, the silane compound may be synthesized by reacting two or more precursor silane compounds. In certain embodiments, the reaction of two or more precursor silane compounds may provide a silane compound reaction product with an advantageously high number of hydrolysable groups that enhance adhesion of the silane compound to a substrate, as explained herein in greater detail. In certain embodiments, for example, the silane compound may be synthesized by reacting a first precursor silane compound comprising a siloxane (e.g., a monomer, a polymer, a copolymer) with a second precursor silane compound (e.g., a monomer, a polymer, a copolymer) in the presence of a catalyst and heat. The resulting reaction product may, in accordance with certain embodiments, be deposited onto at least a portion of at least one surface of a substrate. In certain embodiments, for example, the composition may be sprayed (e.g., spray coated) onto at least a portion of at least one surface of a substrate. After depositing the composition, the composition may be heated (e.g., thermally cured) to provide the coating, in accordance with certain embodiments.

The composition (e.g., coating) may be used for any of a variety of suitable applications. In certain embodiments, for example, the composition may be applied on a substrate such as a glass, plastic, metal, and/or metal oxide, for example, as used in electronic displays such as, but not limited to, cell phone screens, computer monitors, television screens, touch screens, appliances, and/or heads up displays. In some embodiments, the coating may be applied on a substrate for use in transportation vehicles (e.g., cars, aircrafts, and the like) and/or building equipment.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

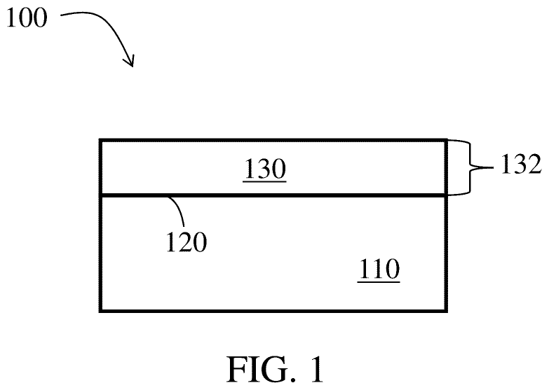

FIG. 1 shows, according to certain embodiments, a schematic diagram of an exemplary article. In certain embodiments, for example, article 100 comprises substrate 110 comprising at least one surface 120. Suitable substrate materials are explained in further detail herein.

In accordance with certain embodiments, composition 130 may be disposed on at least a portion of at least one surface 120 such that composition 130 coats at least the portion of at least one surface 120. In some embodiments, composition 130 comprises a fingerprint inhibition material, which is explained in further detail herein.

While composition 130 coating surface 120 is depicted as a smooth layer of uniform thickness, those of ordinary skill in the art would understand that this is for illustration purposes only and the thickness of the composition coating the surface may have a particular roughness and/or may vary in thickness, in accordance with some embodiments. In certain embodiments, however, the composition coating the surface may be of relatively uniform thickness (e.g., within less than or equal to 10% of the total thickness) over at least a substantial portion of the surface of the substrate (e.g., greater than or equal to 75% of the surface area of the surface of the substrate on which the composition is disposed).

In certain embodiments, the composition coating the surface may have any of a variety of suitable thicknesses. Referring to FIG. 1, for example, composition 130 coating at least the portion of at least one surface 120 may have thickness 132. In some embodiments, the composition coating the surface has an average thickness of greater than or equal to 5 nm, greater than or equal to 10 nm, greater than or equal to 20 nm, greater than or equal to 30 nm, greater than or equal to 40 nm, greater than or equal to 50 nm, greater than or equal to 60 nm, greater than or equal to 70 nm, greater than or equal to 80 nm, or greater than or equal to 90 nm. In certain embodiments, the composition coating the surface has an average thickness of less than or equal to 100 nm, less than or equal to 90 nm, less than or equal to 80 nm, less than or equal to 70 nm, less than or equal to 60 nm, less than or equal to 50 nm, less than or equal to 40 nm, less than or equal to 30 nm, less than or equal to 20 nm, or less than or equal to 10 nm. Combinations of the above recited ranges are possible (e.g., the composition coating the surface has an average thickness of greater than or equal to 5 nm and less than or equal to 100 nm, or greater than or equal to 40 nm and less than or equal to 60 nm). Other ranges are also possible. In certain embodiments, the average thickness of the composition coating the surface may be determined by ellipsometry.

In some embodiments, the composition (e.g., coating) comprises a fingerprint inhibition material. The fingerprint inhibition material is non-fluorinated, in accordance with certain embodiments, such that the fingerprint inhibition material does not comprise any fluorine (F) atoms.

The composition (e.g., coating) may comprise the fingerprint inhibition material in any of a variety of suitable amounts. In certain embodiments, for example, the composition comprises the fingerprint inhibition material in an amount greater than or equal to 0.1 weight percent (wt. %), greater than or equal to 1 wt. %, greater than or equal to 5 wt. %, greater than or equal to 10 wt. %, greater than or equal to 20 wt. %, greater than or equal to 30 wt. %, greater than or equal to 40 wt. %, greater than or equal to 50 wt. %, greater than or equal to 60 wt. %, greater than or equal to 70 wt. %, greater than or equal to 80 wt. %, or greater than or equal to 90 wt. % based on the total weight of the composition. In some embodiments, the composition comprises the fingerprint inhibition material in an amount less than or equal to 100 wt. %, less than or equal to 90 wt. %, less than or equal to 80 wt. %, less than or equal to 70 wt. %, less than or equal to 60 wt. %, less than or equal to 50 wt. %, less than or equal to 40 wt. %, less than or equal to 30 wt. %, less than or equal to 20 wt. %, less than or equal to 10 wt. %, less than or equal to 5 wt. %, or less than or equal to 1 wt. % based on the total weight of the composition. Combinations of the above recited ranges are possible (e.g., the composition comprises the fingerprint inhibition material in an amount greater than or equal to 0.1 wt. % and less than or equal to 100 wt. % based on the total weight of the composition, or greater than or equal to 40 wt. % and less than or equal to 60 wt. % based on the total weight of the composition). Other ranges are also possible.

According to some embodiments, the fingerprint inhibition material comprises a silane compound (e.g., a non-fluorinated silane compound). The silane compound comprises a polysiloxane, in accordance with some embodiments. For example, in some embodiments, the silane compound comprises a repeating unit of ((R)₂—Si—O). In certain embodiments, the silane compound comprising the polysiloxane may linear. In other embodiments, the silane compound comprising the polysiloxane may be branched.

The silane compound may comprise one or more hydrolysable moieties, in accordance with some embodiments. In some embodiments, examples of suitable hydrolysable moieties include, but are not limited to, an alkoxy moiety (e.g., an —OR moiety), a hydroxyl (—OH) moiety, a halogen moiety (e.g., a —Cl moiety, a —Br moiety, and —I moiety), an amine, and/or the like (e.g., other leaving groups). Other hydrolysable moieties are also possible. According to certain embodiments, the silane compound may comprise one or more hydrolyzed moieties (e.g., a hydrolysate of the silane compound). In some embodiments, for example, the one or more hydrolysable moieties may be reacted with a hydrolysis agent, as explained in greater detail below.

According to certain embodiments, the polysiloxane comprises one or more hydrophobic moieties. Advantageously, the one or more hydrophobic moieties may lower the overall surface energy of a composition (e.g., coating) comprising the polysiloxane. In some embodiments, for example, the hydrophobic moiety comprises a methyl silyl (—Si(CH₃)) moiety, a dimethylsilyl (—Si(CH₃)₂) moiety, a trimethylsilyl (—Si(CH₃)₃) moiety, a methylsiloxy (—Si(CH₃)O) moiety, a dimethylsiloxy (—Si(CH₃)₂₀) moiety, a trimethylsiloxy (—Si(CH₃)₃₀) moiety, an alkylene moiety (e.g., a —(CH₂)ₙ— moiety), an alkenylene moiety (e.g., a —(CₙH₂ₙ₋₂)ₙ-moiety), an alkynylene moiety (e.g., a —(CₙH₂ₙ₋₄)ₙ— moiety), and/or the like. Other hydrophobic moieties are also possible.

The silane compound may have any of a variety of suitable molecular weights. In certain embodiments, for example, the silane compound has a molecular weight of greater than or equal to 500 Da, greater than or equal to 1,000 Da, greater than or equal to 5,000 Da, greater than or equal to 10,000 Da, greater than or equal to 20,000 Da, greater than or equal to 30,000 Da, greater than or equal to 40,000 Da, greater than or equal to 50,000 Da, greater than or equal to 75,000 Da, greater than or equal to 100,000 Da, greater than or equal to 200,000 Da, greater than or equal to 300,000 Da, or greater than or equal to 400,000 Da. In some embodiments, the silane compound has a molecular weight of less than or equal to 500,000 Da, less than or equal to 400,000 Da, less than or equal to 300,000 Da, less than or equal to 200,000 Da, less than or equal to 100,000 Da, less than or equal to 50,000 Da, less than or equal to 40,000 Da, less than or equal to 30,000 Da, less than or equal to 20,000 Da, less than or equal to 10,000 Da, less than or equal to 5,000 Da, or less than or equal to 1,000 Da. Combinations of the above recited ranges are possible (e.g., the silane compound has molecular weight of greater than or equal to 500 Da and less than or equal to 500,000 Da, or greater than or equal to 10,000 Da and less than or equal to 20,000 Da). Other ranges are also possible. In some embodiments, the molecular weight of the silane compound is determined by gel permeation chromatography (GPC).

According to some embodiments, the molecular weight of the silane compound may advantageously be tuned depending on the particular application. For example, in some embodiments, a composition comprising a silane compound having a lower molecular weight may have increased optical clarity (e.g., percent optical transmittance) as compared to a composition comprising a silane compound having a higher molecular weight. In certain embodiments, a composition comprising a silane compound having a higher molecular weight may have increased hydrophobicity as compared to a composition comprising a silane compound having a lower molecular weight. Therefore, according to some embodiments, a composition comprising a silane compound having a lower molecular weight may be employed for applications in which a higher percent optical transmittance is desired, while a composition comprising a silane compound having a higher molecular weight may be employed for applications in which a higher hydrophobicity is desired.

According to certain embodiments, the silane compound comprises the structure shown below in Formula (I).

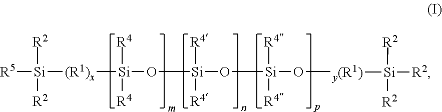

wherein:
each R¹ is the same of different and is selected from the group consisting of oxygen, —C₁-C₁₀ alkylene-, —C₂-C₁₀ alkenylene-, and —C₃-C₁₀ alkynylene-,
each R² is the same or different and is selected from the group consisting of hydrogen, deuterium, —C₁-C₁₀ alkyl, —C₂-C₁₀ alkenyl, —C₃-C₁₀ alkynyl, a halogen, and OR³,
each R³ is the same or different and is selected from the group consisting of hydrogen, deuterium, —C₁-C₁₀ alkyl, —C₂-C₁₀ alkenyl, —C₃-C₁₀ alkynyl, and —Si(R²)₃,
each R⁴, R^{4′}, and R^{4″} is the same or different and is selected from the group consisting of hydrogen, deuterium, —C₁-C₁₀ alkyl, —C₂-C₁₀ alkenyl, —C₃-C₁₀ alkynyl, OR³, —C₁-C₁₀ alkylene-Si(OR³)₃, —C₂-C₁₀ alkenylene-Si(OR³)₃, —C₃-C₁₀ alkynylene-Si(OR³)₃, —C₁-C₁₀ alkylene-(Si(OR³)₃)₂, —C₂-C₁₀ alkenylene-(Si(OR³)₃)₂, —C₃-C₁₀ alkynylene-(Si(OR³)₃)₂, —C₁-C₁₀ alkylene-Si(R²)₂—(R¹)—((R²)₂—Si—O)_{z}—Si(R²)₃, —C₂-C₁₀ alkenylene-Si(R²)₂—(R¹)—((R²)₂—Si—O)_{z}—Si(R²)₃, and —C₃-C₁₀ alkynylene-Si(R²)₂—(R¹)—((R²)₂—Si—O)_{z}—Si(R²)₃,
R⁵ is selected from the group consisting of R² and —R⁶—R⁷—R⁸, wherein R⁶ is selected from the group consisting of —C₁-C₁₀ alkylene-, —C₂-C₁₀ alkenylene-, and —C₃-C₁₀ alkynylene-, wherein R⁷ is selected from the group consisting of oxygen and sulfur, and wherein R⁸ is selected from the group consisting of —C₁₀-C₂₀ alkylene-Si(OR³)₃, —C₁₀-C₂₀ alkenylene-Si(OR³)₃, and —C₁₀-C₂₀ alkynylene-Si(OR³)₃,
x and y are independently 0 or 1,
z is greater than or equal to 1, and
m, n, and/or p are 0 or greater with the proviso that at least one of m, n, or p is greater than or equal to 2.

The value of “m” in the silane compound shown above in Formula (I) may be any of a variety of suitable values. In certain embodiments, for example, “m” is greater than or equal to 0, greater than or equal to 2, greater than or equal to 10, greater than or equal to 50, greater than or equal to 100, greater than or equal to 200, greater than or equal to 300, greater than or equal to 400, greater than or equal to 500, greater than or equal to 600, greater than or equal to 700, greater than or equal to 800, or greater than or equal to 900. In some embodiments, “m” is less than or equal to 1,000, less than or equal to 900, less than or equal to 800, less than or equal to 700, less than or equal to 600, less than or equal to 500, less than or equal to 400, less than or equal to 300, less than or equal to 200, less than or equal to 100, less than or equal to 50, less than or equal to 10, or less than or equal to 2. Combinations of the above recited ranges are possible (e.g., “m” is greater than or equal to 0 and less than or equal to 1,000, or greater than or equal to 10 and less than or equal to 400). Other ranges are also possible.

The value of “n” in the silane compound shown above in Formula (I) may be any of a variety of suitable values. In certain embodiments, for example, “n” is greater than or equal to 0, greater than or equal to 2, greater than or equal to 10, greater than or equal to 50, greater than or equal to 100, greater than or equal to 200, greater than or equal to 300, greater than or equal to 400, greater than or equal to 500, greater than or equal to 600, greater than or equal to 700, greater than or equal to 800, or greater than or equal to 900. In some embodiments, “n” is less than or equal to 1,000, less than or equal to 900, less than or equal to 800, less than or equal to 700, less than or equal to 600, less than or equal to 500, less than or equal to 400, less than or equal to 300, less than or equal to 200, less than or equal to 100, less than or equal to 50, less than or equal to 10, or less than or equal to 2. Combinations of the above recited ranges are possible (e.g., “n” is greater than or equal to 0 and less than or equal to 1,000, or greater than or equal to 10 and less than or equal to 400). Other ranges are also possible.

The value of “p” in the silane compound shown above in Formula (I) may be any of a variety of suitable values. In certain embodiments, for example, “p” is greater than or equal to 0, greater than or equal to 2, greater than or equal to 10, greater than or equal to 50, greater than or equal to 100, greater than or equal to 200, greater than or equal to 300, greater than or equal to 400, greater than or equal to 500, greater than or equal to 600, greater than or equal to 700, greater than or equal to 800, or greater than or equal to 900. In some embodiments, “p” is less than or equal to 1,000, less than or equal to 900, less than or equal to 800, less than or equal to 700, less than or equal to 600, less than or equal to 500, less than or equal to 400, less than or equal to 300, less than or equal to 200, less than or equal to 100, less than or equal to 50, less than or equal to 10, or less than or equal to 2. Combinations of the above recited ranges are possible (e.g., “p” is greater than or equal to 0 and less than or equal to 1,000, or greater than or equal to 10 and less than or equal to 400). Other ranges are also possible.

According to certain embodiments, the polysiloxane comprises polydimethylsiloxane. In certain embodiments, the polydimethylsiloxane comprises a repeating unit of ((CH₃)₂—Si—O).

According to some embodiments, the silane compound comprises the structure shown below in Formula (II).

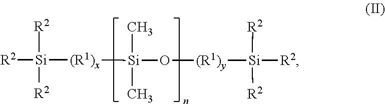

wherein:
each R¹ is the same of different and is selected from the group consisting of oxygen, —C₁-C₁₀ alkylene-, —C₂-C₁₀ alkenylene-, and —C₃-C₁₀ alkynylene-,
each R² is the same or different and is selected from the group consisting of hydrogen, deuterium, —C₁-C₁₀ alkyl, —C₂-C₁₀ alkenyl, —C₃-C₁₀ alkynyl, a halogen, and OR³,
each R³ is the same or different and is selected from the group consisting of hydrogen, deuterium, —C₁-C₁₀ alkyl, —C₂-C₁₀ alkenyl, and —C₃-C₁₀ alkynyl,
x and y are independently 0 or 1, and
n is greater than or equal to 2.

The value of “n” in the silane compound shown above in Formula (II) may be any of a variety of suitable values as described above with respect to Formula (I), provided that the value of “n” is not 0 (e.g., “n” is greater than or equal to 2 and less than or equal to 1,000).

In some embodiments, the polysiloxane comprises a silicon-hydride. In certain embodiments, the silicon hydride comprises a repeating unit of (H—Si—R). In some embodiments, the hydride group may be configured to react with a vinyl (—CH═CH₂) group. In certain embodiments, for example, a composition comprising a polysiloxane comprising a silicon-hydride may advantageously enhance adhesion of the composition to substrate surfaces comprising vinyl groups (e.g., vinyl-primed substrate surfaces) as compared to a polysiloxane that does not comprise a silicon-hydride but is otherwise equivalent.

According to some embodiments, the hydride group may be replaced by one or more polymerizable moieties. In some embodiments, for example, the hydride group may be replaced by a vinyl (—CH═CH₂) group, a —C₃-C₁₀ alkynyl group, and/or a hydroxyl (—OH) group. Other polymerizable moieties are also possible.

In certain embodiments, the silane compound comprises the structure shown below in Formula (III).

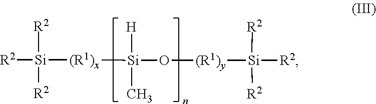

wherein:
each R¹ is the same of different and is selected from the group consisting of oxygen, —C₁-C₁₀ alkylene-, —C₂-C₁₀ alkenylene-, and —C₃-C₁₀ alkynylene-,
each R² is the same or different and is selected from the group consisting of hydrogen, deuterium, —C₁-C₁₀ alkyl, —C₂-C₁₀ alkenyl, —C₃-C₁₀ alkynyl, a halogen, and OR³,
each R³ is the same or different and is selected from the group consisting of hydrogen, deuterium, —C₁-C₁₀ alkyl, —C₂-C₁₀ alkenyl, and —C₃-C₁₀ alkynyl,
x and y are independently 0 or 1, and
n is greater than or equal to 2.

The value of “n” in the silane compound shown above in Formula (III) may be any of a variety of suitable values as described above with respect to Formula (I), provided that the value of “n” is not 0 (e.g., “n” is greater than or equal to 2 and less than or equal to 1,000).

According to certain embodiments, the hydride group in Formula (III) may be replaced by one or more polymerizable groups (e.g., a vinyl group, a —C₃-C₁₀ alkynyl group, and/or a hydroxyl group).

According to certain embodiments, the polysiloxane comprises a polydimethylsiloxane and a silicon-hydride. In certain embodiments, for example, the silane compound comprises the structure shown below in Formula (IV).

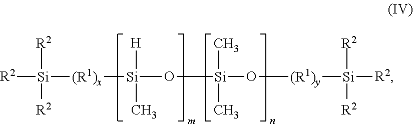

wherein:
each R¹ is the same of different and is selected from the group consisting of oxygen, —C₁-C₁₀ alkylene-, —C₂-C₁₀ alkenylene-, and —C₃-C₁₀ alkynylene-,
each R² is the same or different and is selected from the group consisting of hydrogen, deuterium, —C₁-C₁₀ alkyl, —C₂-C₁₀ alkenyl, —C₃-C₁₀ alkynyl, a halogen, and OR³,
each R³ is the same or different and is selected from the group consisting of hydrogen, deuterium, —C₁-C₁₀ alkyl, —C₂-C₁₀ alkenyl, and —C₃-C₁₀ alkynyl,
x and y are independently 0 or 1, and
m and n are greater than or equal to 2.

The value of “m” in the silane compound shown above in Formula (IV) may be any of a variety of suitable values as described above with respect to Formula (I), provided that the value of “m” is not 0 (e.g., “m” is greater than or equal to 2 and less than or equal to 1,000).

The value of “n” in the silane compound shown above in Formula (IV) may be any of a variety of suitable values as described above with respect to Formula (I), provided that the value of “n” is not 0 (e.g., “n” is greater than or equal to 2 and less than or equal to 1,000).

According to certain embodiments, the hydride group in Formula (IV) may be replaced by one or more polymerizable groups (e.g., a vinyl group, a —C₃-C₁₀ alkynyl group, and/or a hydroxyl group).

According to certain embodiments, the silane compound comprises the structure shown below in Formula (V).

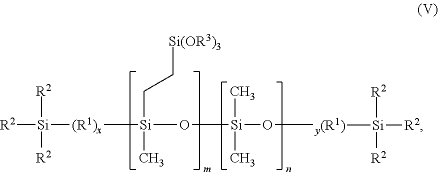

wherein:
each R¹ is the same of different and is selected from the group consisting of oxygen, —C₁-C₁₀ alkylene-, —C₂-C₁₀ alkenylene-, and —C₃-C₁₀ alkynylene-,
each R² is the same or different and is selected from the group consisting of hydrogen, deuterium, —C₁-C₁₀ alkyl, —C₂-C₁₀ alkenyl, —C₃-C₁₀ alkynyl, a halogen, and OR³,
each R³ is the same or different and is selected from the group consisting of hydrogen, deuterium, —C₁-C₁₀ alkyl, —C₂-C₁₀ alkenyl, —C₃-C₁₀ alkynyl, and —Si(R²)₃,
x and y are independently 0 or 1, and
m and n are greater than or equal to 2.

The value of “m” in the silane compound shown above in Formula (V) may be any of a variety of suitable values as described above with respect to Formula (I), provided that the value of “m” is not 0 (e.g., “m” is greater than or equal to 2 and less than or equal to 1,000).

The value of “n” in the silane compound shown above in Formula (V) may be any of a variety of suitable values as described above with respect to Formula (I), provided that the value of “n” is not 0 (e.g., “n” is greater than or equal to 2 and less than or equal to 1,000).

In some embodiments, the silane compound comprises the structure shown below in Formula (VI).

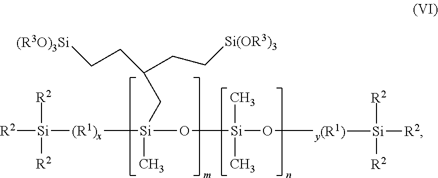

wherein:
each R¹ is the same of different and is selected from the group consisting of oxygen, —C₁-C₁₀ alkylene-, —C₂-C₁₀ alkenylene-, and —C₃-C₁₀ alkynylene-,
each R² is the same or different and is selected from the group consisting of hydrogen, deuterium, —C₁-C₁₀ alkyl, —C₂-C₁₀ alkenyl, —C₃-C₁₀ alkynyl, a halogen, and OR³,
each R³ is the same or different and is selected from the group consisting of hydrogen, deuterium, —C₁-C₁₀ alkyl, —C₂-C₁₀ alkenyl, —C₃-C₁₀ alkynyl, and —Si(R²)₃,
x and y are independently 0 or 1, and
m and n are greater than or equal to 2.

The value of “m” in the silane compound shown above in Formula (VI) may be any of a variety of suitable values as described above with respect to Formula (I), provided that the value of “m” is not 0 (e.g., “m” is greater than or equal to 2 and less than or equal to 1,000).

The value of “n” in the silane compound shown above in Formula (VI) may be any of a variety of suitable values as described above with respect to Formula (I), provided that the value of “n” is not 0 (e.g., “n” is greater than or equal to 2 and less than or equal to 1,000).

According to certain embodiments, the silane compound comprises the structure shown below in Formula (VII).

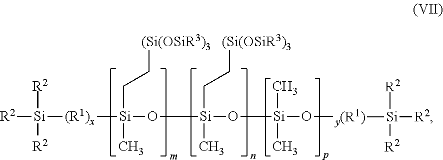

wherein:
each R¹ is the same of different and is selected from the group consisting of oxygen, —C₁-C₁₀ alkylene-, —C₂-C₁₀ alkenylene-, and —C₃-C₁₀ alkynylene-,
each R² is the same or different and is selected from the group consisting of hydrogen, deuterium, —C₁-C₁₀ alkyl, —C₂-C₁₀ alkenyl, —C₃-C₁₀ alkynyl, a halogen, and OR³,
each R³ is the same or different and is selected from the group consisting of hydrogen, deuterium, —C₁-C₁₀ alkyl, —C₂-C₁₀ alkenyl, —C₃-C₁₀ alkynyl, and —Si(R²)₃,
x and y are independently 0 or 1, and
m, n, and p are greater than or equal to 2.

The value of “m” in the silane compound shown above in Formula (VII) may be any of a variety of suitable values as described above with respect to Formula (I), provided that the value of “m” is not 0 (e.g., “m” is greater than or equal to 2 and less than or equal to 1,000).

The value of “n” in the silane compound shown above in Formula (VII) may be any of a variety of suitable values as described above with respect to Formula (I), provided that the value of “n” is not 0 (e.g., “n” is greater than or equal to 2 and less than or equal to 1,000).

The value of “p” in the silane compound shown above in Formula (VII) may be any of a variety of suitable values as described above with respect to Formula (I), provided that the value of “p” is not 0 (e.g., “p” is greater than or equal to 2 and less than or equal to 1,000).

In certain embodiments, the silane compound comprises the structure shown below in Formula (VIII).

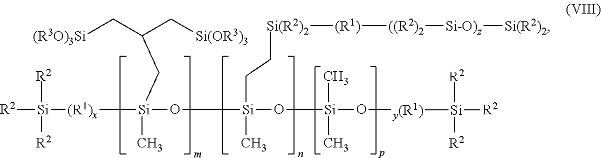

wherein:
each R¹ is the same of different and is selected from the group consisting of oxygen, —C₁-C₁₀ alkylene-, —C₂-C₁₀ alkenylene-, and —C₃-C₁₀ alkynylene-,
each R² is the same or different and is selected from the group consisting of hydrogen, deuterium, —C₁-C₁₀ alkyl, —C₂-C₁₀ alkenyl, —C₃-C₁₀ alkynyl, a halogen, and OR³,
each R³ is the same or different and is selected from the group consisting of hydrogen, deuterium, —C₁-C₁₀ alkyl, —C₂-C₁₀ alkenyl, —C₃-C₁₀ alkynyl, and —Si(R²)₃,
x and y are independently 0 or 1,
z is greater than or equal to 1, and
m, n, and p are greater than or equal to 2.

The value of “m” in the silane compound shown above in Formula (VIII) may be any of a variety of suitable values as described above with respect to Formula (I), provided that the value of “m” is not 0 (e.g., “m” is greater than or equal to 2 and less than or equal to 1,000).

The value of “n” in the silane compound shown above in Formula (VIII) may be any of a variety of suitable values as described above with respect to Formula (I), provided that the value of “n” is not 0 (e.g., “n” is greater than or equal to 2 and less than or equal to 1,000).

The value of “p” in the silane compound shown above in Formula (VIII) may be any of a variety of suitable values as described above with respect to Formula (I), provided that the value of “p” is not 0 (e.g., “p” is greater than or equal to 2 and less than or equal to 1,000).

According to some embodiments, the silane compound comprises the structure shown below in Formula (IX).

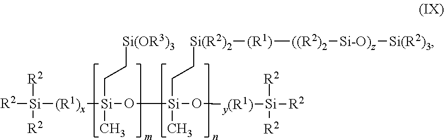

wherein:
each R¹ is the same of different and is selected from the group consisting of oxygen, —C₁-C₁₀ alkylene-, —C₂-C₁₀ alkenylene-, and —C₃-C₁₀ alkynylene-,
each R² is the same or different and is selected from the group consisting of hydrogen, deuterium, —C₁-C₁₀ alkyl, —C₂-C₁₀ alkenyl, —C₃-C₁₀ alkynyl, a halogen, and OR³,
each R³ is the same or different and is selected from the group consisting of hydrogen, deuterium, —C₁-C₁₀ alkyl, —C₂-C₁₀ alkenyl, —C₃-C₁₀ alkynyl, and —Si(R²)₃,
x and y are independently 0 or 1,
z is greater than or equal to 1, and
m and n are greater than or equal to 2.

The value of “m” in the silane compound shown above in Formula (IX) may be any of a variety of suitable values as described above with respect to Formula (I), provided that the value of “m” is not 0 (e.g., “m” is greater than or equal to 2 and less than or equal to 1,000).

The value of “n” in the silane compound shown above in Formula (IX) may be any of a variety of suitable values as described above with respect to Formula (I), provided that the value of “n” is not 0 (e.g., “n” is greater than or equal to 2 and less than or equal to 1,000).

In some embodiments, the silane compound comprises the structure shown below in Formula (X).

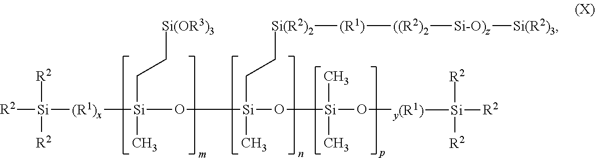

wherein:
each R¹ is the same of different and is selected from the group consisting of oxygen, —C₁-C₁₀ alkylene-, —C₂-C₁₀ alkenylene-, and —C₃-C₁₀ alkynylene-,
each R² is the same or different and is selected from the group consisting of hydrogen, deuterium, —C₁-C₁₀ alkyl, —C₂-C₁₀ alkenyl, —C₃-C₁₀ alkynyl, a halogen, and OR³,
each R³ is the same or different and is selected from the group consisting of hydrogen, deuterium, —C₁-C₁₀ alkyl, —C₂-C₁₀ alkenyl, —C₃-C₁₀ alkynyl, and —Si(R²)₃,
x and y are independently 0 or 1,
z is greater than or equal to 1, and
m, n, and p are greater than or equal to 2.

The value of “m” in the silane compound shown above in Formula (X) may be any of a variety of suitable values as described above with respect to Formula (I), provided that the value of “m” is not 0 (e.g., “m” is greater than or equal to 2 and less than or equal to 1,000).

The value of “n” in the silane compound shown above in Formula (X) may be any of a variety of suitable values as described above with respect to Formula (I), provided that the value of “n” is not 0 (e.g., “n” is greater than or equal to 2 and less than or equal to 1,000).

The value of “p” in the silane compound shown above in Formula (X) may be any of a variety of suitable values as described above with respect to Formula (I), provided that the value of “p” is not 0 (e.g., “p” is greater than or equal to 2 and less than or equal to 1,000).

According to certain embodiments, the silane compound comprises the structure shown below in Formula (XI).

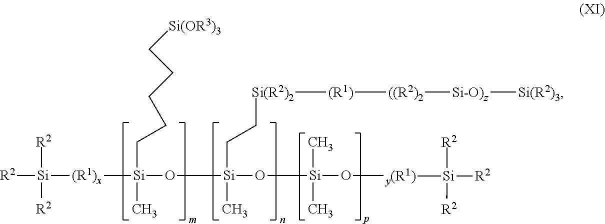

wherein:
each R¹ is the same of different and is selected from the group consisting of oxygen, —C₁-C₁₀ alkylene-, —C₂-C₁₀ alkenylene-, and —C₃-C₁₀ alkynylene-,
each R² is the same or different and is selected from the group consisting of hydrogen, deuterium, —C₁-C₁₀ alkyl, —C₂-C₁₀ alkenyl, —C₃-C₁₀ alkynyl, a halogen, and OR³,
each R³ is the same or different and is selected from the group consisting of hydrogen, deuterium, —C₁-C₁₀ alkyl, —C₂-C₁₀ alkenyl, —C₃-C₁₀ alkynyl, and —Si(R²)₃,
x and y are independently 0 or 1,
z is greater than or equal to 1, and
m, n, and p are greater than or equal to 2.

The value of “m” in the silane compound shown above in Formula (XI) may be any of a variety of suitable values as described above with respect to Formula (I), provided that the value of “m” is not 0 (e.g., “m” is greater than or equal to 2 and less than or equal to 1,000).

The value of “n” in the silane compound shown above in Formula (XI) may be any of a variety of suitable values as described above with respect to Formula (I), provided that the value of “n” is not 0 (e.g., “n” is greater than or equal to 2 and less than or equal to 1,000).

The value of “p” in the silane compound shown above in Formula (XI) may be any of a variety of suitable values as described above with respect to Formula (I), provided that the value of “p” is not 0 (e.g., “p” is greater than or equal to 2 and less than or equal to 1,000).

As described herein, the silane compound may comprise an ether moiety or a thioether moiety, according to certain embodiments. In some embodiments, for example, R⁵ in Formula (I) is —R⁶—R⁷—R⁸, wherein R⁷ is oxygen or sulfur.

In certain embodiments, R⁶ is selected from the group consisting of —C₁-C₁₀ alkylene-, —C₂-C₁₀ alkenylene-, and —C₃-C₁₀ alkynylene-. In some embodiments, for example, R⁶ is —C₁-C₁₀ alkylene— (e.g., —(CH₂)—, —(CH₂)₂—, —(CH₂)₃—, —(CH₂)₄—, —(CH₂)₅—, etc.).

R⁸ may, in certain embodiments, comprise a long alkylene, alkenylene, and/or alkynylene chain. Advantageously, the long alkylene, alkenylene, and/or alkynylene chain may provide the silane compound with an increased hydrophobicity as compared to a silane compound that does not comprise the long alkylene, alkenylene, and/or alkynylene chain but is otherwise equivalent. In some embodiments, for example, R⁸ is selected from the group consisting of —C₁₀-C₂₀ alkylene-Si(OR³)₃, —C₁₀-C₂₀ alkenylene-Si(OR³)₃, and —C₁₀-C₂₀ alkynylene-Si(OR³)₃, wherein R³ is the same or different and is selected from the group consisting of hydrogen, deuterium, —C₁-C₁₀ alkyl, —C₂-C₁₀ alkenyl, and —C₃-C₁₀ alkynyl. In certain embodiments, R⁸ is —C₁₀-C₂₀ alkylene-Si(OR³)₃ (e.g., —(CH₂)₁₀—Si(OR³)₃, —(CH₂)₁₁—Si(OR³)₃, —(CH₂)₁₂—Si(OR³)₃, —(CH₂)₁₃—Si(OR³)₃, —(CH₂)₁₄—Si(OR³)₃, etc.), wherein R³ is the same or different and is selected from the group consisting of hydrogen and —C₁-C₁₀ alkyl.

According to some embodiments, the silane compound comprises the structure shown below in Formula (XII).

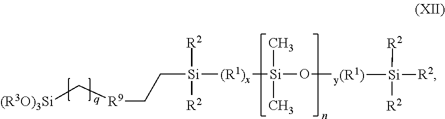

wherein:
each R¹ is the same of different and is selected from the group consisting of oxygen, —C₁-C₁₀ alkylene-, —C₂-C₁₀ alkenylene-, and —C₃-C₁₀ alkynylene-,
each R² is the same or different and is selected from the group consisting of hydrogen, deuterium, —C₁-C₁₀ alkyl, —C₂-C₁₀ alkenyl, —C₃-C₁₀ alkynyl, a halogen, and OR³,
each R³ is the same or different and is selected from the group consisting of hydrogen, deuterium, —C₁-C₁₀ alkyl, —C₂-C₁₀ alkenyl, and —C₃-C₁₀ alkynyl, R⁹ is selected from the group consisting of oxygen and sulfur,
x and y are independently 0 or 1,
n is greater than or equal to 2, and
q is greater than or equal to 10 and less than or equal to 20.

The value of “n” in the silane compound shown above in Formula (XII) may be any of a variety of suitable values as described above with respect to Formula (I), provided that the value of “n” is not 0 (e.g., “n” is greater than or equal to 2 and less than or equal to 1,000).

In certain embodiments, a method of synthesizing the silane compound is described. In certain embodiments, for example, the method comprises reacting a first precursor silane compound comprising a siloxane (e.g., a monomer, a polymer, a copolymer) with a second precursor silane compound (e.g., a monomer, a polymer, a copolymer). In other embodiments, the method comprises reacting a first precursor silane compound comprising a siloxane (e.g., a monomer, a polymer, a copolymer) with a second precursor silane compound (e.g., a monomer, a polymer, a copolymer) and a third precursor silane compound (e.g., a monomer, a polymer, a copolymer). The second and/or the third precursor silane compound may, in some embodiments, comprise a siloxane.

The first precursor silane compound may comprise any of a variety of silane compounds comprising a siloxane. In certain embodiments, for example, the first precursor silane compound comprises: methylhydrosiloxane and dimethylsiloxane copolymer; trimethylsilyl-terminated polymethylhydrosiloxane; vinyl T-structure polymer, vinyltris(trimethylsiloxy)silane; monovinyl-terminated polydimethylsiloxane, and/or derivatives thereof. Other first precursor silane compounds are also possible.

The second precursor silane compound and/or the third precursor silane compound may comprise any of a variety of suitable silane compounds. In some embodiments, for example, the second precursor silane compound and/or the third precursor silane compound comprises: vinyltriethoxysilane; 1,1-bis(trimethoxysilymethyl)ethane; 1,1-bis(triethoxysilylethane); 5-hexenyltriethoxysilane; 11-mercaptotriethoxysilane; 1,1,2-tris(triethoxysilyl)ethane; 1,1-bis(trichlorosilyl)ethane; and/or derivatives thereof. Other second precursor silane compounds and/or third precursor silane compounds are also possible.

In certain embodiments, the second precursor silane compound and/or the third precursor silane compound may comprise a silane compound comprising a siloxane. In some such embodiments, any of the siloxane-containing compounds described above with respect to the first precursor silane compound may be employed.

The first precursor silane compound, the second precursor silane compound, and/or the third precursor silane compound may be reacted in any of a variety suitable reaction solvents. In certain embodiments, for example, the reaction solvent may comprise toluene, tetrahydrofuran (THF), methyl ethyl ketone (MEK), and/or isopropyl alcohol (IPA). Other reaction solvents are also possible as the disclosure is not meant to be limiting in this regard.

In some embodiments, the first precursor silane compound, the second precursor silane compound, and/or the third precursor silane compound are reacted in the presence of a catalyst. The catalyst may comprise any of a variety of materials. In certain embodiments, for example, the catalyst comprises platinum metal (Pt⁰) and/or a hydroxide salt (e.g., potassium hydroxide (KOH), sodium hydroxide (NaOH), etc.). Other catalysts are also possible as the disclosure is not meant to be limiting in this regard.

In certain embodiments, the first precursor silane compound, the second precursor silane compound, and/or the third precursor silane compound are reacted in the presence of heat. In certain embodiments, for example, the first precursor silane compound, the second precursor silane compound, and/or the third precursor silane compound are reacted at a temperature greater than or equal to room temperature (RT) (e.g., 20-22° C.), greater than or equal to 25° C., greater than or equal to 50° C., greater than or equal to 75° C., greater than or equal to 100° C., or greater than or equal to 125° C. In certain embodiments, the first precursor silane compound, the second precursor silane compound, and/or the third precursor silane compound are reacted a temperature less than or equal to 150° C., less than or equal to 125° C., less than or equal to 100° C., less than or equal to 75° C., less than or equal to 50° C., or less than or equal to 25° C. Combinations of the above recited ranges are possible (e.g., the first precursor silane compound, the second precursor silane compound, and/or the third precursor silane compound are reacted at a temperature greater than or equal to RT and less than or equal to 150° C., or greater than or equal to 75° C. and less than or equal to 100° C.). Other ranges are also possible.

In some embodiments, the temperature at which the first precursor silane compound, the second precursor silane compound, and/or the third precursor silane compound are reacted depends on the reaction solvent. In certain embodiments, for example, the first precursor silane compound, the second precursor silane compound, and/or the third precursor silane compound are reacted at a reflux temperature of the reaction solvent.

The first precursor silane compound, the second precursor silane compound, and/or the third precursor silane compound may be reacted for any of a variety of suitable times. In certain embodiments, for example, the first precursor silane compound, the second precursor silane compound, and/or the third precursor silane compound are reacted for greater than or equal to 1 hour, greater than or equal to 5 hours, greater than or equal to 10 hours, greater than or equal to 24 hours, greater than or equal to 48 hours, or greater than or equal to 72 hours. In some embodiments, the first precursor silane compound, the second precursor silane compound, and/or the third precursor silane compound are reacted for less than or equal to 96 hours, less than or equal to 72 hours, less than or equal to 48 hours, less than or equal to 24 hours, less than or equal to 10 hours, or less than or equal to 5 hours. Combinations of the above recited ranges are possible (e.g., the first precursor silane compound, the second precursor silane compound, and/or the third precursor silane compound are reacted for greater than or equal to 1 hour and less than or equal to 96 hours, the first precursor silane compound, the second precursor silane compound, and/or the third precursor silane compound are reacted for greater than or equal to 10 hours and less than or equal to 24 hours). Other ranges are also possible.

According to some embodiments, the precursor silane compounds (e.g., the first precursor silane compound, the second precursor silane compound, and/or the third precursor silane compound) may be synthesized by methods known to those of ordinary skill in the art. In other embodiments, the precursor silane compounds (e.g., the first precursor silane compound, the second precursor silane compound, and/or the third precursor silane compound) may be purchased commercially (e.g., from Siltech Corporation, Gelest, Inc.).

Additional precursor silane compounds may be employed during the synthesis of the silane compound, as the disclosure is not meant to be limiting in this regard. In some embodiments, for example, the method comprises reacting a first precursor silane compound comprising a siloxane with a second precursor silane compound, a third precursor silane compound, a fourth precursor silane compound, a fifth precursor silane compound, etc. In some such embodiments, the additional precursor silane compounds may comprise any of the precursor silane compounds described herein with respect to the first precursor silane compound, the second precursor silane compound, and/or the third precursor silane compound.

In certain embodiments, the composition (e.g., fingerprint inhibition material) comprises one or more hydrolysis agents. According to some embodiments, the hydrolysis agent may advantageously hydrolyze at least a portion of the silane compound, thereby providing a hydrolysate of the silane compound. Without wishing to be bound by theory, a composition comprising the hydrolysate of the silane compound may have improved durability as compared to a composition comprising the silane compound that is not hydrolyzed but is otherwise equivalent, while maintaining hydrophobicity, oleophobicity, and lubricity. In some embodiments, a composition comprising the hydrolysate of the silane compound may exhibit enhanced adhesion to a substrate as compared to a composition comprising the silane compound that is not hydrolyzed but is otherwise equivalent, while maintaining hydrophobicity, oleophobicity, and lubricity. The silane compound may be reacted with the hydrolysis agent prior to, during, and/or after disposing a composition comprising the silane compound onto at least a portion of at least one surface of a substrate, as explained herein in greater detail.

The composition (e.g., fingerprint inhibition material) may comprise any of a variety of suitable hydrolysis agents. In certain embodiments, for example, the hydrolysis agent comprises DBTDL. In some embodiments, the hydrolysis agent comprises an acid or a base. Other hydrolysis agents are also possible.

The composition (e.g., fingerprint inhibition material) may comprise any of a variety of suitable amounts of the one or more hydrolysis agents. In certain embodiments, for example, the composition comprises the one or more hydrolysis agents in an amount greater than or equal to 0.1 wt. %, greater than or equal to 1 wt. %, greater than or equal to 2 wt. %, greater than or equal to 4 wt. %, greater than or equal to 6 wt. %, greater than or equal to 8 wt. %, or greater than or equal to 10 wt. % versus the total weight of the composition. In some embodiments, the composition comprises the one or more hydrolysis agents in an amount less than or equal to 15 wt. %, less than or equal to 10 wt. %, less than or equal to 5 wt. %, less than or equal to 4 wt. %, less than or equal to 3 wt. %, less than or equal to 2 wt. %, or less than or equal to 1 wt. % versus the total weight of the composition. Combinations of the above recited ranges are possible (e.g., the composition comprises the one or more hydrolysis agents in an amount greater than or equal to 0.1 wt. % and less than or equal to 15 wt. % versus the total weight of the composition, or greater than or equal to 8 wt. % and less than or equal to 10 wt. % versus the total weight of the composition). Other ranges are also possible.

According to certain embodiments, the composition (e.g., fingerprint inhibition material) comprises one or more adhesion promoters. In some embodiments, the one or more adhesion promoters may advantageously improve the water contact angle, diiodomethane contact angle, and/or the durability of the composition comprising the one or more adhesion promoters as compared to a composition that does not comprise the one or more adhesion promoters but is otherwise equivalent. Without wishing to be bound be theory, the one or more adhesion promoters may provide a higher number of silane bonding groups per unit surface area of the composition as compared to a composition that does not comprise the one or more adhesion promoters but is otherwise equivalent.

The composition (e.g., fingerprint inhibition material) may comprise any of a variety of suitable adhesion promoters. In some embodiments, for example, the composition comprises tetraethylorthosilicate (TEOS), 1,2-bis(triethoxysilyl)ethane, 1,1,2-tris(ethoxysilyl)ethane, and/or derivatives thereof. Other adhesion promoters are also possible.

The composition (e.g., fingerprint inhibition material) may comprise the one or more adhesion promoters in any of a variety of suitable amounts. In certain embodiments, for example, the composition comprises the one or more adhesion promoters in an amount greater than or equal to 0.1 wt. %, greater than or equal to 1 wt. %, greater than or equal to 2 wt. %, greater than or equal to 3 wt. %, greater than or equal to 4 wt. %, greater than or equal to 5 wt. % versus the total weight of the composition, greater than or equal to 10 wt. %, greater than or equal to 15 wt. %, or greater than or equal to 20 wt. % versus the total weight of the composition. In some embodiments, the composition comprises the one or more adhesion promoters in an amount less than or equal to 25 wt. %, less than or equal to 20 wt. %, less than or equal to 15 wt. %, less than or equal to 10 wt. %, less than or equal to 5 wt. %, less than or equal to 4 wt. %, less than or equal to 3 wt. %, less than or equal to 2 wt. %, or less than or equal to 1 wt. % versus the total weight of the composition. Combinations of the above recited ranges are possible (e.g., the composition comprises the one or more adhesion promoters in an amount greater than or equal to 0.1 wt. % and less than or equal to 25 wt. % versus the total weight of the composition, or greater than or equal to 5 wt. % and less than or equal to 10 wt. % versus the total weight of the composition). Other ranges are also possible.

According to certain embodiments, the silane compound of the composition (e.g., fingerprint inhibition material) is immobilized on at least a portion of the at least one surface of the substrate. Referring to FIG. 1, for example, the silane compound of composition 130 is immobilized on at least a portion of at least one surface 120 of substrate 110. In some embodiments, for example, the silane compound of composition 130 is chemically bound (e.g., covalently bound, non-covalently bound) to at least a portion of at least one surface 120 of substrate 110. Examples of bonding interactions include, in some embodiments, covalent bonds, ionic bonds, van der Waals forces, hydrogen bonding, dipole interactions, coordination, chelation, and the like. In certain embodiments, the silane compound of the composition is immobilized on at least a portion of at least one surface of the substrate via at least one —Si—O— linkage.

According to certain embodiments, the substrate is optically transparent. The substrate may have any of a variety of suitable percent optical transmittances. In some embodiments, for example, the percent optical transmittance of the substrate is greater than or equal to 90%, greater than or equal to 92%, greater than or equal to 94%, greater than or equal to 96%, greater than or equal to 98%, or greater than or equal to 99%. In some embodiments, the percent optical transmittance of the substrate is less than or equal to 100%, less than or equal to 99%, less than or equal to 98%, less than or equal to 96%, less than or equal to 94%, or less than or equal to 92%. Combinations of the above recited ranges are possible (e.g., the percent optical transmittance of substrate is greater than or equal to 90% and less than or equal to 100%, or greater than or equal to 98% and less than or equal to 99%). Other ranges are also possible. According to certain embodiments, the percent optical transmittance of the substrate is determined using a spectrophotometer.

The substrate may comprise any of a variety of suitable materials. In certain embodiments, for example, the substrate comprises glass, a ceramic, a metal, a metal oxide, a polymer (e.g., an acrylic polymer, a plastic), and/or an electronic component (e.g., a silicon wafer). In certain embodiments, the substrate may comprise a coating (e.g., a coating comprising vinyl groups, such as a vinyl primer). Other materials are also possible.

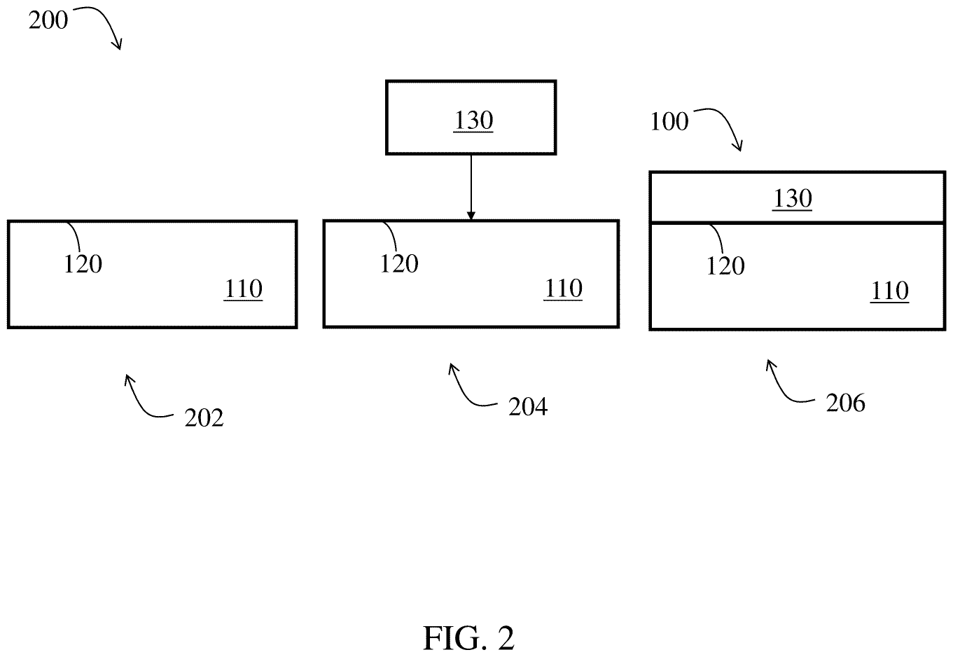

In certain embodiments, a method of coating a substrate is described. FIG. 2 shows, according to certain embodiments, a schematic diagram of an exemplary method of coating a substrate.

In some embodiments, step 202 of method 200 comprises providing substrate 110 comprising at least one surface 120. According to some embodiments, the method comprises activating at least a portion of a substrate. In certain embodiments, for example, the substrate is activated by exposing the substrate to a plasma of inert gas, such as, but not limited to, Ar, Ne, He, N₂, O₂, H₂O, and/or mixtures thereof. In some embodiments, the substrate is activated by mechanically treating the surface with a metal oxide or acid etching (e.g., with hydrofluoric acid or hydrochloric acid). Without wishing to be bound by theory, as a result of activating at the substrate, the density of hydroxyl (—OH) moieties on the surface of the substrate is increased, thereby facilitating immobilization (e.g., bonding) of the silane compound on the surface of the substrate, as is explained in greater detail herein.

Step 204 of method 200 comprises, in accordance with certain embodiments, disposing (e.g., depositing) composition 130 (e.g., fingerprint inhibition material) on at least a portion of at least one surface 120 of substrate 110 such that composition 130 coats at least the portion of at least one surface 120 of substrate 110. In certain embodiments, as explained herein in greater detail, as a result of disposing the composition on at least a portion of the at least one surface of the substrate, the silane compound of the composition may be immobilized (e.g., bound) to the surface of the substrate.

Depositing the composition (e.g., fingerprint inhibition material) may comprise any of a variety of suitable deposition methods. According to certain embodiments, for example, depositing the composition comprises spraying (e.g., spray coating), spinning (e.g., spin coating), dipping (dip coating), wiping, chemical vapor deposition (CVD), and/or physical vapor deposition (PVD).

Although not shown in the figures, a composition comprising the fingerprint inhibition material may be reacted with one or more additional components prior to depositing the composition on at least a portion of at least one surface of a substrate. In certain embodiments, for example, the fingerprint inhibition material may be reacted with one or more hydrolysis agents and/or adhesion promoters prior to depositing the composition on at least a portion of at least one surface of a substrate. In certain embodiments wherein a composition comprising the fingerprint inhibition material is reacted with one or more hydrolysis agents prior to depositing the composition on at least a portion of at least one surface of a substrate, the one or more hydrolysis agents may hydrolyze the silane compound of the composition (e.g., thereby providing a hydrolysate of the silane compound) prior to depositing the composition on at least the portion of at least one surface of the substrate.

Although not shown in the figures, a composition comprising the fingerprint inhibition material and one or more additional components may be deposited onto at least a portion of at least one surface of a substrate, in accordance with certain embodiments. In some embodiments, for example, a composition comprising a mixture of the fingerprint inhibition material and one or more hydrolysis agents and/or adhesion promoters may be deposited onto at least a portion of at least one surface of a substrate. In some embodiments wherein a composition comprises a mixture of the fingerprint inhibition material and the one or more hydrolysis agents that are deposited onto at least a portion of at least one surface of a substrate, the one or more hydrolysis agents may hydrolyze the silane compound of the composition (e.g., thereby providing a hydrolysate of the silane compound) while the composition is deposited onto at least the portion of the at least one surface of the substrate. In other embodiments wherein a composition comprises a mixture of the fingerprint inhibition material and the one or more hydrolysis agents that are deposited onto at least a portion of at least one surface of a substrate, the one or more hydrolysis agents may hydrolyze the silane compound of the composition (e.g., thereby providing a hydrolysate of the silane compound) after the composition is deposited onto at least the portion of the at least one surface of the substrate.

According to certain embodiments, coating the substrate may comprise heating (e.g., curing, annealing) the composition (e.g., fingerprint inhibition material) disposed on at least a portion of the at least one surface of the substrate, thereby providing article 100 in step 206.

The composition (e.g., fingerprint inhibition material) may be heated (e.g., cured) to any of a variety of suitable temperatures. In some embodiments, for example, the composition is heated (e.g., cured) to a temperature greater than or equal to 25° C., greater than or equal to 50° C., greater than or equal to 75° C., greater than or equal to 100° C., greater than or equal to 110° C., greater than or equal to 120° C., greater than or equal to 130° C., or greater than or equal to 140° C. In certain embodiments, the composition is heated (e.g., cured) to a temperature less than or equal to 150° C., less than or equal to 140° C., less than or equal to 130° C., less than or equal to 120° C., less than or equal to 110° C., less than or equal to 100° C., less than or equal to 75° C., or less than or equal to 50° C. Combinations of the above recited ranges are possible (e.g., the composition is heated to a temperature greater than or equal to 25° C. and less than or equal to 150° C., or greater than or equal to 120° C. and less than or equal to 140° C.). Other ranges are also possible.

The composition (e.g., fingerprint inhibition material) may be heated to any of the aforementioned temperatures for any or a variety of suitable times. In certain embodiments, for example, the composition is heated (e.g., cured) for greater than or equal to 1 minute, greater than or equal to 30 minutes, greater than or equal to 1 hour, greater than or equal to 5 hours, greater than or equal to 10 hours, greater than or equal to 24 hours, greater than or equal to 48 hours, or greater than or equal to 72 hours. In some embodiments, the composition is heated (e.g., cured) for less than or equal to 96 hours, less than or equal to 72 hours, less than or equal to 48 hours, less than or equal to 24 hours, less than or equal to 10 hours, less than or equal to 5 hours, less than or equal to 1 hour, or less than or equal to 30 minutes. Combinations of the above recited ranges are possible (e.g., the composition is heated for greater than or equal to 1 minute and less than or equal to 96 hours, the composition is heated for greater than or equal to 10 hours and less than or equal to 24 hours). Other ranges are also possible.

In some embodiments, the amount of time that the composition is heated depends on the temperature at which the composition is heated. In certain embodiments, for example, higher composition heating temperatures (e.g., greater than or equal to 100° C.) are associated with lower composition heating times (e.g., less than or equal to 1 hour). In some embodiments, lower composition heating temperatures (e.g., less than or equal to 75° C.) are associated with higher composition heating times (e.g., greater than or equal to 5 hours).

In certain embodiments, the amount of time that the composition is heated and/or the temperature at which the composition is heated depends on the substrate on which the composition is disposed (e.g., deposited). In certain embodiments, for example, higher composition heating temperatures (e.g., greater than or equal to 100° C.) and lower composition heating times (e.g., less than or equal to 1 hour) are associated with compositions disposed (e.g., deposited) on glass substrates. In some embodiments, lower composition heating temperatures (e.g., less than or equal to 75° C.) and higher composition heating times (e.g., greater than or equal to 5 hours) are associated with compositions disposed (e.g., deposited) on polymer (e.g., plastic) substrates.

According to certain embodiments, the coating comprising the fingerprint inhibition material (e.g., the anti-fingerprint coating) may be hydrophobic. The coating comprising the fingerprint inhibition material (e.g., the anti-fingerprint coating) may have any of a variety of suitable water contact angles. In some embodiments, for example, the coating comprising the fingerprint inhibition material has a water contact angle of greater than or equal to 90°, greater than or equal to 95°, greater than or equal to 100°, greater than or equal to 105°, greater than or equal to 110°, greater than or equal to 115°, greater than or equal to 120°, greater than or equal to 125°, greater than or equal to 130°, greater than or equal to 135°, greater than or equal to 140°, greater than or equal to 145°, greater than or equal to 150°, greater than or equal to 155°, greater than or equal to 160°, greater than or equal to 165°, greater than or equal to 170°, or greater than or equal to 175°. In certain embodiments, the coating comprising the fingerprint inhibition material has a water contact angle of less than or equal to 180°, less than or equal to 175°, less than or equal to 170°, less than or equal to 165°, less than or equal to 160°, less than or equal to 155°, less than or equal to 150°, less than or equal to 145°, less than or equal to 140°, less than or equal to 135°, less than or equal to 130°, less than or equal to 125°, less than or equal to 120°, less than or equal to 115°, less than or equal to 110°, less than or equal to 100°, or less than or equal to 95°. Combinations of the above recited ranges are possible (e.g., the coating comprising the fingerprint inhibition material has a water contact angle of greater than or equal to 90° and less than or equal to 180°, or greater than or equal to 130° and less than or equal to) 140°. Other ranges are also possible. In certain embodiments, the water contact angle of the coating comprising the fingerprint inhibition material is determined by a goniometer.

In some embodiments, the coating comprising the fingerprint inhibition material (e.g., the anti-fingerprint coating) may be oleophobic. The coating comprising the fingerprint inhibition material (e.g., the anti-fingerprint coating) may have any of a variety of suitable diiodomethane contact angles. In certain embodiments, for example, the coating comprising the fingerprint inhibition material has a diiodomethane contact angle of greater than or equal to 55°, greater than or equal to 60°, greater than or equal to 65°, greater than or equal to 70°, greater than or equal to 75°, greater than or equal to 80°, greater than or equal to 85°, greater than or equal to 90°, greater than or equal to 95°, greater than or equal to 100°, greater than or equal to 105°, greater than or equal to 110°, greater than or equal to 115°, greater than or equal to 120°, greater than or equal to 125°, greater than or equal to 130°, greater than or equal to 135°, greater than or equal to 140°, greater than or equal to 145°, greater than or equal to 150°, greater than or equal to 155°, greater than or equal to 160°, greater than or equal to 165°, greater than or equal to 170°, or greater than or equal to 175°. In some embodiments, the coating comprising the fingerprint inhibition material has a diiodomethane contact angle of less than or equal to 180°, less than or equal to 175°, less than or equal to 170°, less than or equal to 165°, less than or equal to 160°, less than or equal to 155°, less than or equal to 150°, less than or equal to 145°, less than or equal to 140°, less than or equal to 135°, less than or equal to 130°, less than or equal to 125°, less than or equal to 120°, less than or equal to 115°, less than or equal to 110°, less than or equal to 105°, less than or equal to 100°, less than or equal to 95°, less than or equal to 90°, less than or equal to 85°, less than or equal to 80°, less than or equal to 75°, less than or equal to 70°, less than or equal to 65°, or less than or equal to 60°. Combinations of the above recited ranges are possible (e.g., the coating comprising the fingerprint inhibition material has a diiodomethane contact angle of greater than or equal to 55° and less than or equal to 180°, or greater than or equal to 110° and less than or equal to) 120°. Other ranges are also possible. In certain embodiments, the diiodomethane contact angle of the coating comprising the fingerprint inhibition material is measured by a goniometer.

Conventional substrates and coatings disposed thereon are subject to mechanical abrasion, which degrades, wears away, and/or otherwise diminishes the coating thickness, transparency, and/or effectiveness of the coating overtime. Abrasion occurs during substrate handling by the user, such as by rubbing with a cloth to remove unwanted materials (e.g., to remove dirt), which is periodically necessary for restoring satisfactory visibility through the coating. In some embodiments, degradation may result from exposure to ultraviolet radiation, heat, cold, chemicals, salts and/or other corrosive materials, dirt, other abrasive materials, and/or other environmental elements, conditions, and/or materials.

In certain embodiments, the coating (e.g., anti-fingerprint coating) may be durable. In some embodiments, for example, the coating has a particular abrasion resistance as measured by the water contact angle and/or diiodomethane contact angle after a certain number of abrasions. In certain embodiments, the abrasion method is based off a linear abrader setup using eraser abrasion. In some embodiments, the abrasion method is based off ASTM D1044.

According to certain embodiments, the water contact angle of the coating (e.g., anti-fingerprint coating) may decrease by any of a variety of suitable percentages after a number of linear abrasion cycles. In some embodiments, for example, the water contact angle of the coating (e.g., anti-fingerprint coating) decreases by less than or equal to 50%, less than or equal to 40%, less than or equal to 30%, less than or equal to 20%, less than or equal to 10%, or less than or equal to 5% after 3,000 linear abrasion cycles, after 4,000 linear abrasion cycles, and/or after 5,000 linear abrasion cycles. In certain embodiments, the water contact angle of the coating (e.g., anti-fingerprint coating) decreases by greater than or equal to 1%, greater than or equal to 5%, greater than or equal to 10%, greater than or equal to 20%, greater than or equal to 30%, or greater than or equal to 40% after 3,000 linear abrasion cycles, after 4,000 linear abrasion cycles, and/or after 5,000 linear abrasion cycles. Combinations of the above recited ranges are possible (e.g., the water contact angle of the coating decreases by less than or equal to 50% and greater than or equal to 1% after 3,000 linear abrasion cycles, after 4,000 linear abrasion cycles, and/or after 5,000 linear abrasion cycles, the water contact angle of the coating decreases by less than or equal to 30% and greater than or equal to 20% after 3,000 linear abrasion cycles, after 4,000 linear abrasion cycles, and/or after 5,000 linear abrasion cycles). Other ranges are also possible.

According to some embodiments, the diiodomethane contact angle of the coating (e.g., anti-fingerprint coating) may decrease by any of a variety of suitable percentages after a number of linear abrasion cycles. In certain embodiments, for example, the diiodomethane contact angle of the coating (e.g., anti-fingerprint coating) decreases by less than or equal to 50%, less than or equal to 40%, less than or equal to 30%, less than or equal to 20%, less than or equal to 10%, or less than or equal to 5% after 3,000 linear abrasion cycles, after 4,000 linear abrasion cycles, and/or after 5,000 linear abrasion cycles. In certain embodiments, the diiodomethane angle of the coating (e.g., anti-fingerprint coating) decreases by greater than or equal to 1%, greater than or equal to 5%, greater than or equal to 10%, greater than or equal to 20%, greater than or equal to 30%, or greater than or equal to 40% after 3,000 linear abrasion cycles, after 4,000 linear abrasion cycles, and/or after 5,000 linear abrasion cycles. Combinations of the above recited ranges are possible (e.g., the diiodomethane contact angle of the coating decreases by less than or equal to 50% and greater than or equal to 1% after 3,000 linear abrasion cycles, after 4,000 linear abrasion cycles, and/or after 5,000 linear abrasion cycles, the diiodomethane contact angle of the coating decreases by less than or equal to 30% and greater than or equal to 20% after 3,000 linear abrasion cycles, after 4,000 linear abrasion cycles, and/or after 5,000 linear abrasion cycles). Other ranges are also possible.

In certain embodiments, the coating (e.g., anti-fingerprint coating) may be lubricious. The coating (e.g., anti-fingerprint coating) may have any of a variety of suitable coefficient of friction values. In certain embodiments, for example, the coefficient of friction of the coating (e.g., anti-fingerprint coating) is less than or equal to 0.15, less than or equal to 0.1, less than or equal to 0.09, less than or equal to 0.08, less than or equal to 0.07, less than or equal to 0.06, less than or equal to 0.05, less than or equal to 0.04, less than or equal to 0.03, or less than or equal to 0.02. In some embodiments, the coefficient of friction of the coating (e.g., anti-fingerprint coating) is greater than or equal to 0.01, greater than or equal to 0.02, greater than or equal to 0.03, greater than or equal to 0.04, greater than or equal to 0.05, greater than or equal to 0.06, greater than or equal to 0.07, greater than or equal to 0.08, greater than or equal to 0.09, or greater than or equal to 0.1. Combinations of the above recited ranges are possible (e.g., the coefficient of friction of the coating is less than or equal to 0.15 and greater than or equal to 0.01, or less than or equal to 0.07 and greater than or equal to 0.05). Other ranges are also possible. According to some embodiments, the coefficient of friction of the coating is determined using a portable friction meter muse.

In certain embodiments, the coating (e.g., anti-fingerprint coating) may be optically transparent. The coating (e.g., anti-fingerprint coating) may have any of a variety of suitable percent optical transmittances. In certain embodiments, for example, the percent optical transmittance of the coating (e.g., anti-fingerprint coating) is greater than or equal to 90%, greater than or equal to 92%, greater than or equal to 94%, greater than or equal to 96%, greater than or equal to 98%, or greater than or equal to 99%. In some embodiments, the percent optical transmittance of the coating (e.g., anti-fingerprint coating) is less than or equal to 100%, less than or equal to 99%, less than or equal to 98%, less than or equal to 96%, less than or equal to 94%, or less than or equal to 92%. Combinations of the above recited ranges are possible (e.g., the percent optical transmittance of the coating is greater than or equal to 90% and less than or equal to 100%, or greater than or equal to 94% and less than or equal to 96%). Other ranges are also possible. According to certain embodiments, the percent optical transmittance of the fingerprint inhibition material is determined by using a spectrophotometer.

According to certain embodiments, a kit is described, the kit comprising a fingerprint inhibition material (e.g., a non-fluorinated fingerprint inhibition material). In some embodiments, the fingerprint inhibition material comprises a silane compound (e.g., comprising a polysiloxane), as described herein. In certain embodiments, the kit may comprise one or more solvents configured to dissolve the fingerprint inhibition material. In other embodiments, the kit may comprise one or more solutions comprising the fingerprint inhibition material. For example, in certain embodiments, the kit may comprise the fingerprint inhibition material pre-dissolved in one or more solvents and ready for application onto a surface of a substrate.

In certain embodiments, the kit may comprise one or more additional components, such as one or more hydrolysis agents and/or one or more adhesion promoters. The one or more hydrolysis agents may be configured to hydrolyze the silane compound (e.g., thereby providing a hydrolysate of the silane compound), as explained herein in greater detail.

As described herein, the composition (e.g., anti-fingerprint coating) may be coated on a substrate comprising a transparent material, such as glass or plastic. According to certain embodiments, the coated substrate may be suitable for use as an article in transportation vehicles and/or equipment. For example, articles for use in transportation vehicles and/or equipment include, but are not limited to, exterior parts of an automobile, aircraft, watercraft, and/or train, such as outer plates, window glass (e.g., windshield, side windows, rear windows, sunroof), mirrors, and/or display panels, and interior parts of an automobile, aircraft, watercraft, and/or train, such as instrument panels and/or displays. In some embodiments, the coated substrate may be suitable for use as an article in building equipment. For example, articles for use in building equipment include, but are not limited to, furniture, base materials (e.g., glass plates or glass windows for roofs, doors, partitions, and/or greenhouses), transparent plastic plates or windows to be used instead of or in addition to glass, and wall materials (e.g., ceramics, cement, etc.).

In certain embodiments, the composition (e.g., anti-fingerprint coating) may be coated on a substrate that is suitable for use in electronic devices. In some embodiments, for example, the composition may be coated onto an electronic component, such as a silicon wafer. According to certain embodiments, the composition may be coated onto an article for use in electronic displays, such as, but not limited to, cell phone screens, computer monitors, television screens, touch screens, appliances, and/or heads up displays.

Definitions of specific functional groups and chemical terms are described in more detail below. For purposes of this invention, the chemical elements are identified in accordance with the Periodic Table of the Elements, CAS version, Handbook of Chemistry and Physics, 75th Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito: 1999, the entire contents of which are incorporated herein by reference.

It will be appreciated that the compounds, as described herein, may be substituted with any number of substituents or functional moieties. In general, the term “substituted” whether preceded by the term “optionally” or not, and substituents contained in formulas of this invention, refer to the replacement of hydrogen radicals in a given structure with the radical of a specified substituent (e.g., a substituent which upon substitution results in a stable compound, such as a compound which does not spontaneously undergo transformation such as by rearrangement, cyclization, elimination, or other reaction). When more than one position in any given structure may be substituted with more than one substituent selected from a specified group, the substituent may be either the same or different at every position. As used herein, the term “substituted” is contemplated to include all permissible substituents of organic compounds, and includes any of the substituents described herein that results in the formation of a stable compounds. In a broad aspect, the permissible substituents include acyclic and cyclic, branched and unbranched, carbocyclic and heterocyclic, aromatic and nonaromatic substituents of organic compounds. For purposes of this invention, heteroatoms such as nitrogen may have hydrogen substituents and/or any permissible substituents of organic compounds described herein which satisfy the valencies of the heteroatoms and results in the formation of a stable moiety. Furthermore, this invention is not intended to be limited in any manner by the permissible substituents of organic compounds. Combinations of substituents and variables envisioned by this invention are preferably those that result in the formation of stable compounds useful in fingerprint inhibition applications. The term “stable”, as used herein, preferably refers to compounds which possess stability sufficient to allow manufacture and which maintain the integrity of the compound for a sufficient period of time to be detected and preferably for a sufficient period of time to be useful for the purposes detailed herein.

As used herein, “alkyl” refers to a radical of a straight-chain or branched saturated hydrocarbon group having from 1 to 10 carbon atoms (“C₁-C₁₀ alkyl”). In some embodiments, an alkyl group has 1 to 9 carbon atoms (“C₁-C₉ alkyl”). In some embodiments, an alkyl group has 1 to 8 carbon atoms (“C₁-C₈ alkyl”). In some embodiments, an alkyl group has 1 to 7 carbon atoms (“C₁-C₇ alkyl”). In some embodiments, an alkyl group has 1 to 6 carbon atoms (“C₁-C₆ alkyl”). In some embodiments, an alkyl group has 1 to 5 carbon atoms (“C₁-C₅ alkyl”). In some embodiments, an alkyl group has 1 to 4 carbon atoms (“C₁-C₄ alkyl”). In some embodiments, an alkyl group has 1 to 3 carbon atoms (“C₁-C₃ alkyl”). In some embodiments, an alkyl group has 1 to 2 carbon atoms (“C₁-C₂ alkyl”). In some embodiments, an alkyl group has 1 carbon atom (“C₁ alkyl”). In some embodiments, an alkyl group has 2 to 6 carbon atoms (“C₂-C₆ alkyl”). Examples of C₁-C₆ alkyl groups include methyl (C₁), ethyl (C₂), n-propyl (C₃), isopropyl (C₃), n-butyl (C₄), tert-butyl (C₄), sec-butyl (C₄), iso-butyl (C₄), n-pentyl (C₅), 3-pentanyl (C₅), amyl (C₅), neopentyl (C₅), 3-methyl-2-butanyl (C₅), tertiary amyl (C₅), and n-hexyl (C₆). Additional examples of alkyl groups include n-heptyl (C₇), n-octyl (C₈), and the like. Unless otherwise specified, each instance of an alkyl group is independently unsubstituted (an “unsubstituted alkyl”) or substituted (a “substituted alkyl”) with one or more substituents. In certain embodiments, the alkyl group is an unsubstituted C₁-C₁₀ alkyl (e.g., —CH₃). In certain embodiments, the alkyl group is a substituted C₁-C₁₀ alkyl.

As used herein, the term “alkenyl” includes a radical of a straight-chain or branched saturated hydrocarbon group having from 2 to 10 carbon atoms, and also includes at least one carbon-carbon double bond. It will be understood that in certain embodiments, alkenyl may be advantageously of limited length, including C₂-C₁₀, C₂-C₉, C₂-C₈, C₂-C₇, C₂-C₆, C₂-C₅, C₂-C₄, and C₂-C₃.

As used herein, the term “alkynyl” includes a radical of a straight-chain or branched saturated hydrocarbon group having from 3 to 10 carbon atoms, and also includes at least one carbon-carbon triple bond. It will be understood that in certain embodiments, alkenyl may be advantageously of limited length, including C₃-C₁₀, C₃-C₉, C₃-C₈, C₃-C₇, C₃-C₆, C₃-C₅, and C₃-C₄.

It should be understood that affixing the suffix “-ene” to a group indicates the group is a divalent moiety. For example, alkylene is the divalent moiety of alkyl (e.g., an acyclic carbon or a saturated acyclic carbon chain represented by the formula —CₙH₂ₙ—), alkenylene is the divalent moiety of alkenyl (e.g., an acyclic carbon chain which contains a carbon-to-carbon double bond represented by the formula —CₙH₂ₙ₋₂—), and alkynylene is the divalent moiety of alkynyl (e.g., an acyclic carbon chain which contains a carbon-to-carbon triple bond represented by the formula —CₙH₂ₙ₋₄—). Affixing the suffice “-yne” to a group indicates the group is trivalent moiety (e.g., alkylyne is the trivalent moiety of alkyl, alkenylyne is the trivalent moiety of alkenyl, and alkynylyne is the trivalent moiety of alkynyl).

As used herein, the term “halogen” refers to fluorine (fluoro, —F), chlorine (chloro, —Cl), bromine (bromo, —Br), or iodine (iodo, —I).

As used herein, the term “hydroxy” or “hydroxyl” refers to an —OH group.

As used herein, the term “alkoxy” refers to an —O-(alkyl) or an —O-(cycloalkyl) group. Representative alkoxy group examples include, but are not limited to, methoxy, ethoxy, propoxy, butoxy, cyclopropyloxy, cyclobutyloxy, cyclopentyloxy, and the like.

As understood from the above, alkyl, alkylene, and alkylyne groups, as defined herein, are, in certain embodiments, optionally substituted. Optionally substituted refers to a group which may be substituted or unsubstituted (e.g., “substituted” or “unsubstituted” alkyl).

The following examples are intended to illustrate certain embodiments of the present invention, but do not exemplify the full scope of the invention.

### Example 1

The following example describes the synthesis and characterization of coatings comprising a silane compound comprising a polysiloxane.

Linear difunctional silane terminated polydimethylsiloxanes, namely Silmer TMS Di-10 (1,100 g/mol), Silmer TMS Di-50 (3,800 g/mol), and Silmer TMS Di-400 (30,000 g/mol), were purchased from Siltech Corporation. Anhydrous ethanol (94-96%) and isopropyl alcohol (98+%) were purchased from Alfa Aesar. Nitric acid (70%) was purchased from Sigma-Aldrich. All materials were used as is without further purification.

TMS Di-10, TMS Di-50, and TMS Di-400 were separately dissolved in ethanol/isopropyl alcohol followed by addition of 70% nitric acid to each solution. The solutions were spray coated on glass substrates. The coated samples were thermally cured in an oven at 120° C. for 24 hours. Subsequently, the coated samples were allowed to cool down to room temperature.

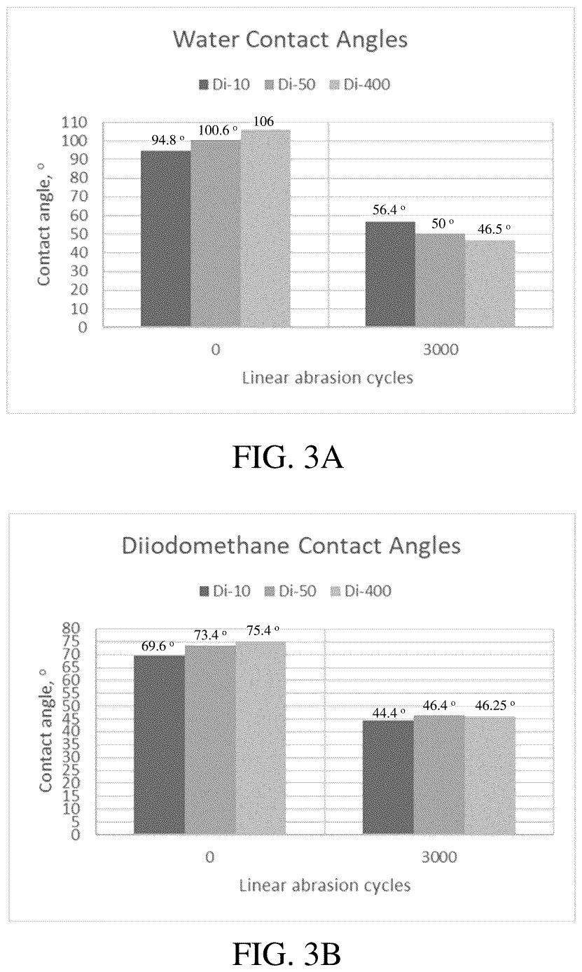

The water and diiodomethane contact angles of the coatings were measured using a goniometer and the durability of the coatings was assessed by eraser abrasion using a linear abrader setup. The water contact angles of TMS Di-10, TMS Di-50, and TMS Di-400 before and after 3,000 eraser linear abrasion cycles are shown in FIG. 3A. The diiodomethane contact angles of TMS Di-10, TMS Di-50, and TMS Di-400 before and after 3,000 eraser linear abrasion cycles are shown in FIG. 3B. The initial water and diiodomethane contact angles increased with an increase in the molecular weight of the materials. In contrast, the water contact angle after 3,000 abrasion cycles decreased with an increase in the molecular weight of the materials, while the diiodomethane contact angle after 3,000 abrasion cycles remained substantially constant as the molecular weight of the materials increased.

### Example 2

The following example describes the synthesis and characterization of coatings comprising a silane compound comprising a polysiloxane reacted with a hydrolysis agent to induce hydrolysis of the silane compound.

A linear difunctional silane terminated polydimethylsiloxane, namely Silmer TMS Di-10 (1100 g/mol), was purchased from Siltech Corporation. DBTDL was purchased from Sigma-Aldrich. Isopropyl alcohol (98+%) was purchased from Alfa Aesar. All materials were used without further purification.

TMS Di-10 was added to a reactor open to the ambient atmosphere followed by the addition of 0.1 wt. % DBTDL versus the total weight of TMS Di-10. The reaction mixture was allowed to stir for 23 hours.

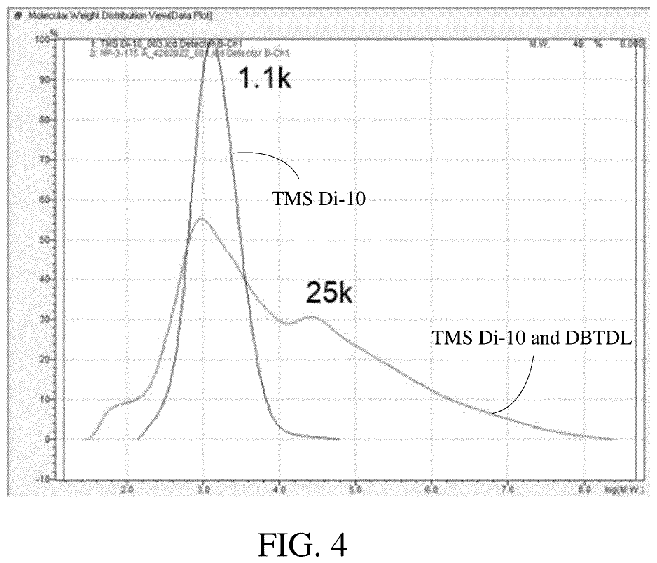

Upon completion of the reaction, GPC analysis was performed on the reaction product. FIG. 4 shows the comparison of the molecular weight distribution of the reaction product of TMS Di-10 and DBTDL as compared to TMS Di-10. The molecular weight distribution of the reaction product of TMS Di-10 and DBTDL was found to be higher than TMS Di-10, indicating hydrolysis condensation of the alkoxysilane moieties.

The reaction product of TMS Di-10 and DBTDL was dissolved in isopropyl alcohol and spray coated on glass substrates. The coated samples were thermally cured at 120° C. for 15-30 minutes. Subsequently, the coated samples were allowed to cool down to room temperature.

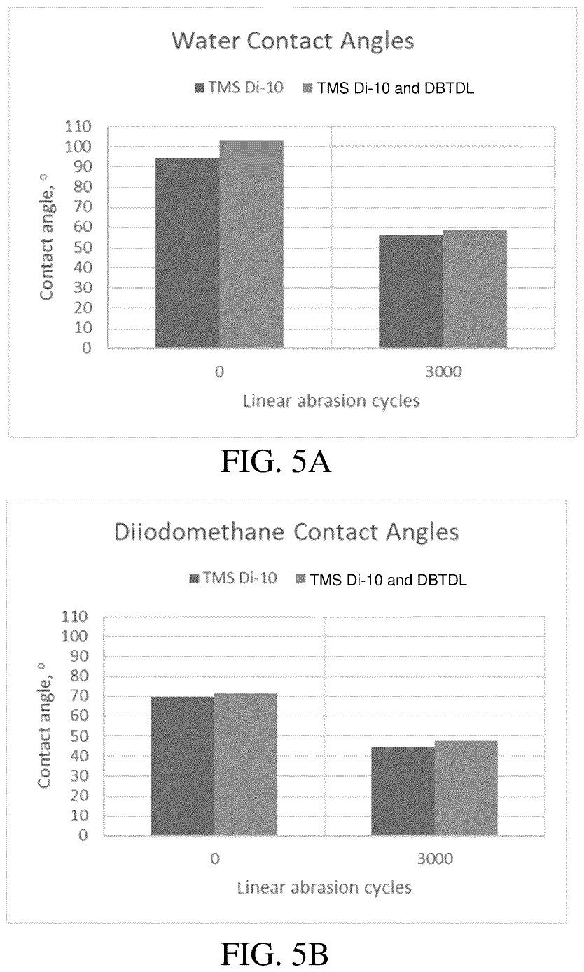

The water and diiodomethane contact angles of the coatings were measured using a goniometer and the durability of the coatings were assessed by eraser abrasion using a linear abrader setup. The water contact angles of the reaction product of TMS Di-10 and DBTDL as compared to TMS Di-10 before and after 3,000 eraser linear abrasion cycles are shown in FIG. 5A. The diiodomethane contact angles of the reaction product of TMS Di-10 and DBTDL as compared to TMS Di-10 before and after 3,000 eraser linear abrasion cycles are shown in FIG. 5B. The initial water and diiodomethane contact angles increased by ≤10° with an increase in the crosslinking density of the material. No significant effect was seen on the durability of the coatings as the water and diiodomethane contact angles after 3,000 abrasion cycles did not change significantly.

### Example 3

The following example describes the synthesis and characterization of coatings comprising a silane compound comprising a polysiloxane reacted with a hydrolysis agent in a 90:10 weight ratio, respectively, to induce hydrolysis of the silane compound.

A linear difunctional silane terminated polydimethylsiloxane, namely Silmer TMS Di-10 (1100 g/mol) was purchased from Siltech Corporation. DBTDL was purchased from Sigma-Aldrich. Anhydrous ethanol (94-96%) was purchased from Alfa Aesar. All materials were used as is without further purification.

TMS Di-10 was mixed with DBTDL in a 90:10 weight ratio, respectively. The mixture was dissolved in ethanol and spray coated on glass substrates. The coated samples were thermally cured in the oven at 120° C. for 24 hours.

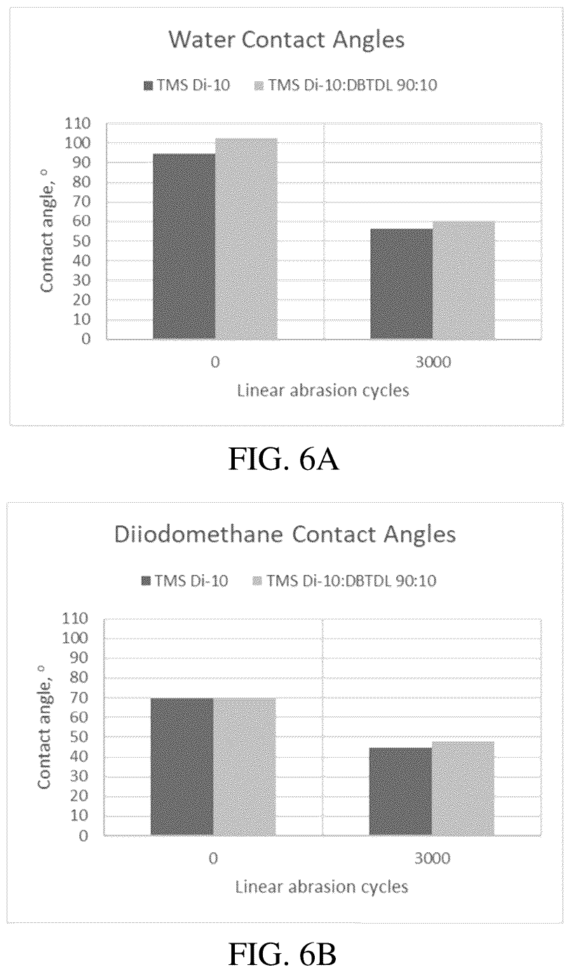

The water and diiodomethane contact angles of the coatings were measured using a goniometer and the durability of the coatings was assessed by eraser abrasion using a linear abrader setup. The water contact angles of the reaction product of TMS-Di 10 and DBTDL in the 90:10 weight ratio as compared to TMS Di-10 before and after 3,000 eraser linear abrasion cycles are shown in FIG. 6A. The diiodomethane contact angles of the reaction product of TMS-Di 10 and DBTDL in the 90:10 weight ratio as compared to TMS Di-10 before and after 3,000 eraser linear abrasion cycles are shown in FIG. 6B. The initial water contact angle of the reaction product of TMS Di-10 and DBTDL in the 90:10 weight ratio increased by ≤10° as compared to TMS Di-10. The durability of the coatings was slightly improved as there was a ≤5° improvement in the water and diiodomethane contact angles after 3,000 abrasion cycles.

### Example 4

The following example describes the synthesis of various silane compounds comprising a polysiloxane.

Synthesis of a silane compound shown in Formula (V): A 25 milliliter round bottom flask was charged with 2 grams of methylhydrosiloxane and dimethylsiloxane copolymer (Gelest, HMS-501, 900-1200 g/mol) and 3.61 grams of vinyltriethoxysilane (Gelest, SIV9112.0) with 15 milliliters of toluene. The reaction mixture was sparged with argon gas for 30 minutes. A catalytic amount of platinum metal was added to the reaction mixture. The reaction mixture was slowly heated up to 95° C. and was allowed to stir for 20 hours. The reaction mixture was concentrated without further purification and 5.1 grams of a clear oil was obtained.

Synthesis of a silane compound shown in Formula (VI): A 25 milliliter round bottom flask was charged with 1 gram of methylhydrosiloxane and dimethylsiloxane copolymer (Gelest, HMS-501, 900-1200 g/mol) and 2.82 g of 1,1-bis(trimethoxysilymethyl)ethane (Gelest, SIB1832.5) with 12 milliliters of toluene. The reaction mixture was sparged with argon gas for 30 minutes. A catalytic amount of platinum metal was added to the reaction mixture. The reaction mixture was slowly heated up to 95° C. and was allowed to stir for 20 hours. The reaction mixture was concentrated without further purification and 3.8 grams of a clear oil was obtained.

Synthesis of a silane compound shown in Formula (VII): A 25 milliliter round bottom flask was charged 2 grams of methylhydrosiloxane and dimethylsiloxane copolymer (Gelest, HMS-501, 900-1200 g/mol), 0.6 grams of vinyltris(trimethylsiloxy)silane (Gelest, SIV9300.0, 322.7 g/mol), and 0.72 grams of vinyltriethoxysilane (Gelest, SIV9112.0, 190.31 g/mol) with 15 milliliters of toluene. The reaction mixture was sparged with argon gas for 30 minutes. A catalytic amount of platinum metal was added to the reaction mixture. The reaction mixture was slowly heated up to 95° C. and was allowed to stir for 20 hours. The reaction mixture was concentrated without further purification and 3.2 grams of a clear oil was obtained.

Synthesis of a silane compound shown in Formula (VIII): A 25 milliliter round bottom flask was charged with 0.6 grams of trimethylsilyl-terminated polymethylhydrosiloxane (Gelest, HMS-991, 1400-1800 g/mol), 4.5 grams of monovinyl-terminated polydimehtylsiloxane (Gelest, MCR-V21, 5500-6500 g/mol), and 0.2 grams of 1,1-bis(triethoxysilylethane) (Gelest, SIB1832.5, 296.47 g/mol) with 20 milliliters of toluene. The reaction mixture was sparged with argon gas for 30 minutes. A catalytic amount of platinum metal was added to the reaction mixture. The reaction mixture was slowly heated up to 95° C. and was allowed to stir for 20 hours. The reaction mixture was concentrated without further purification and 4.8 grams of a clear oil was obtained.

Synthesis of a silane compound shown in Formula (IX): A 25 milliliter round bottom flask was charged 2 grams of methylhydrosiloxane and dimethylsiloxane copolymer (Gelest, HMS-501, 900-1200 g/mol), 0.7 grams of vinyl T-structure polymer (Gelest, VTT-106, 500-900 g/mol), and 0.7 grams of vinyltriethoxysilane (Gelest, SIV9112.0, 190.31 g/mol) with 12 milliliters of toluene. The reaction mixture was sparged with argon gas for 30 minutes. A catalytic amount of platinum metal was added to the reaction mixture. The reaction mixture was slowly heated up to 95° C. and was allowed to stir for 20 hours. The reaction mixture was concentrated without further purification and 3.4 grams of a clear oil was obtained.

Synthesis of a silane compound shown in Formula (X): A 25 milliliter round bottom flask was charged with 2 grams of methylhydrosiloxane and dimethylsiloxane copolymer (Gelest, HMS-501, 900-1200 g/mol), 5.4 grams of monovinyl-terminated polydimethylsiloxane (Gelest, MCR-V21, 5500-6500 g/mol), and 0.7 grams of vinyltriethoxysilane (Gelest, SIV9112.0, 190.31 g/mol) with 25 milliliters of toluene. The reaction mixture was sparged with argon gas for 30 minutes. A catalytic amount of platinum metal was added to the reaction mixture. The reaction mixture was slowly heated up to 95° C. and was allowed to stir for 20 hours. The reaction mixture was concentrated without further purification and 4.1 grams of a clear oil was obtained.

Synthesis of a silane compound shown in Formula (XI): A 100 milliliter round bottom flask was charged with 1 gram of trimethylsilyl-terminated polymethylhydrosiloxane (Gelest, HMS-991, 1400-1800 g/mol), 7.5 grams of monovinyl-terminated polydimehtylsiloxane (Gelest, MCR-V21, 5500-6500 g/mol), and 0.7 grams of 5-hexenyltriethoxysilane (Gelest, SIH6164.2, 246.43 g/mol) with 25 milliliters of toluene. The reaction mixture was sparged with argon gas for 30 minutes. A catalytic amount of platinum metal was added to the reaction mixture. The reaction mixture was slowly heated up to 95° C. and was allowed to stir for 20 hours. The reaction mixture was concentrated without further purification and 8.6 grams of a clear oil was obtained.

### Example 5

The following example describes the synthesis of a silane compound comprising a polysiloxane and a thioether.

A 25 milliliter round bottom flask was charged with 11-mercaptotriethoxysilane (1.72 grams, 5.5 mmol) and bis(triethoxysilyl)ethane (0.34 grams, 0.95 mmol) with 10 milliliters of isopropyl alcohol. A catalytic amount of potassium hydroxide was added to the reaction mixture. The reaction mixture was allowed to stir at room temperature for three days. The reaction mixture was concentrated in-vacuo without further purification, and 2 grams of a mercapto hydrolysate product was obtained.

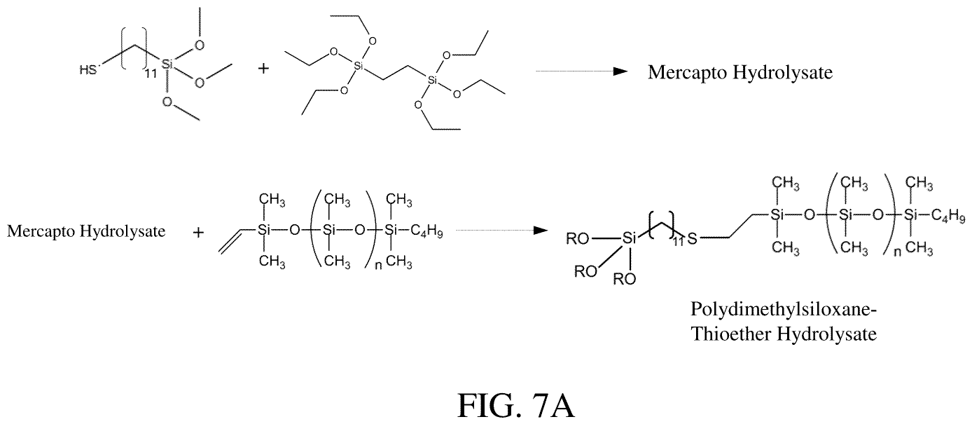

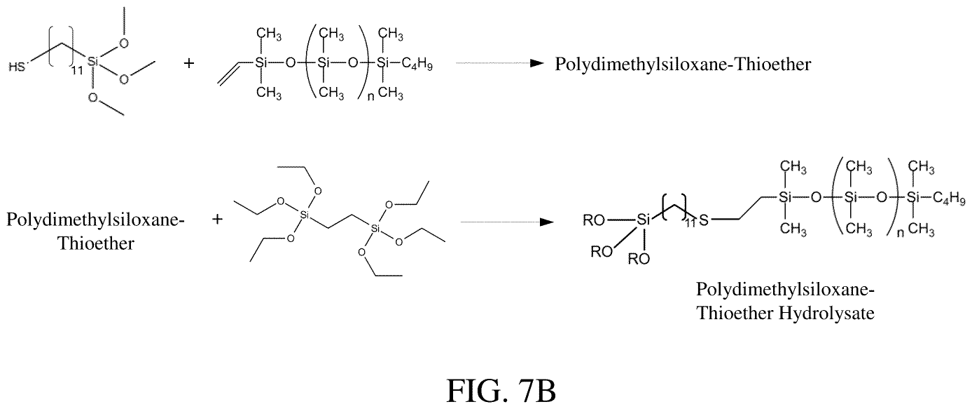

A 25 milliliter round bottom flask was then charged with the mercapto hydrolysate (0.72 g, 2 mmol of thiol), mono-vinyl polydimethylsiloxane (2.6 g, 2 mmol of vinyl) and azobisisobutyronitrile (AIBN) (0.065 g, 0.4 mmol) with 15 milliliters of THF. The reaction mixture was refluxed for a day. The reaction mixture was filtered through a polytetrafluoroethylene (PTFE) filter and the organic filtrate was concentrated in-vacuo, and 3.4 grams of a polydimethylsiloxane-thioether hydrolysate product was obtained. See FIG. 7A.

### Example 6

The following example describes an alternate synthesis of a silane compound comprising a polysiloxane and a thioether.

A 25 milliliter round bottom flask was charged with 11-mercaptotriethoxysilane (0.71 grams, 2.3 mmol), mono-vinyl polydimethylsiloxane (3.0 grams, 2.3 mmol) and AIBN (0.15 grams, 0.4 mmol) with 15 milliliters of THF. The reaction mixture was refluxed for days. The reaction mixture was filtered through a PTFE membrane (1 micrometer). The organic filtrate was concentrated in-vacuo without further purification, and 3.4 grams of a polydimethylsiloxane-thioether hydrolysate product was obtained.

A 25 milliliter round bottom flask was then charged with the polydimethylsiloxane-thioether hydrolysate (2.1 grams) and bis-(triethoxysilyl)ethane (0.42 grams, 1.1 mmol) with 12 milliliters of isopropyl alcohol. A catalytic amount of potassium hydroxide was added to the reaction mixture. The reaction mixture was allowed to stir for two days. The reaction mixture was concentrated in-vacuo without further purification, and 2.4 grams of a polydimethylsiloxane-thioether hydrolysate product was obtained. See FIG. 7B.

### Example 7

The following example describes the characterization of coatings comprising a silane compound shown in Formula (VIII).

A silane compound shown in Formula (VIII) was prepared in MEK and sprayed on glass substrates.

Separately, a silane compound shown in Formula (VIII) was prepared in MEK followed by the addition of 10 wt. % of TEOS versus the total weight of the silane compound. The resulting solution was sprayed on glass substrates.

The coated articles were cured at either 125° C. in an oven for 24 hours or in a 100% relative humidity (RH) chamber at room temperature for 24 hours. The coated articles were thoroughly polished after curing.

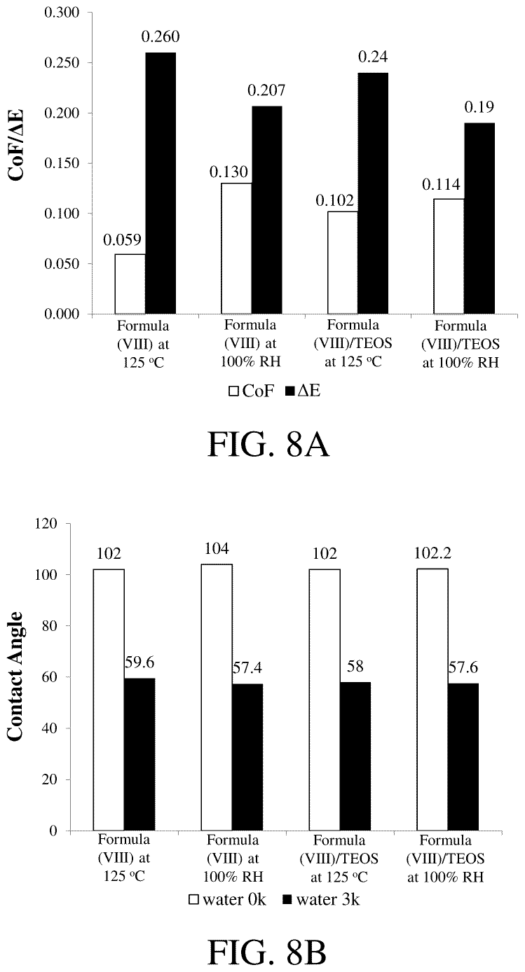

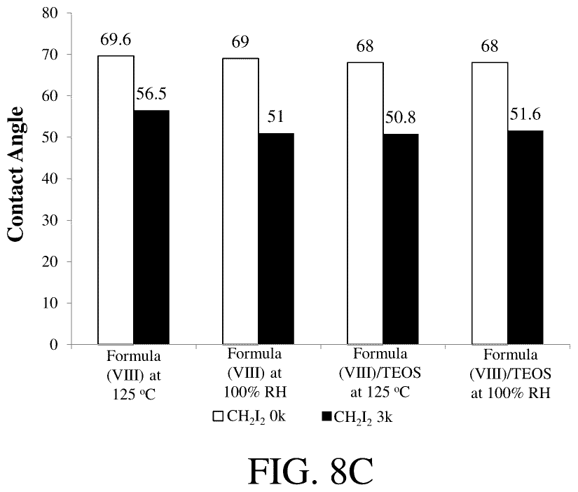

The coefficient of friction (CoF) values of five different locations on the coated articles were randomly evaluated and averaged out. The CoF was measured using a portable friction meter muse (Heidon, VCM system). The color difference (AE) values of five different locations on the coated articles were randomly evaluated and averaged out. The AE was measured using a PCE CSM 5 colorimeter. See FIG. 8A.

The coated articled were subjected to a linear abrasion testing apparatus. The stroke conditions were as follows:
Stroke distance: 5 cm;
Stroke speed: 60/min;
Weight load: 1 kg; and
Abrasive: Minoan eraser.

The linear abrasion was repeated up to 3,000 cycles. The water contact angles and diiodomethane contact angles of the abraded area of each article were measured. The contact angles were obtained from five different locations and averaged out. Each droplet of water and diiodomethane was 5 microliters. See FIGS. 8B-8C.

### Example 8

The following example describes the characterization of coatings comprising a silane compound shown in Formula (VI) compared to coatings comprising a silane compound shown in Formula (XII).

Two samples of silane compounds shown in Formula (VI) with varying values of “m” were prepared in MEK and sprayed on glass substrates.

Separately, two samples of silane compounds shown in Formula (XII) with varying values of “n” were prepared in MEK and sprayed on glass substrates.

The coated articles were cured at 125° C. for 15-30 minutes. The coated articles were thoroughly polished after curing.

The coated articled were subjected to a linear abrasion testing apparatus. The stroke conditions were as follows:
Stroke distance: 5 cm;
Stroke speed: 60/min;
Weight load: 1 kg; and
Abrasive: Minoan eraser.

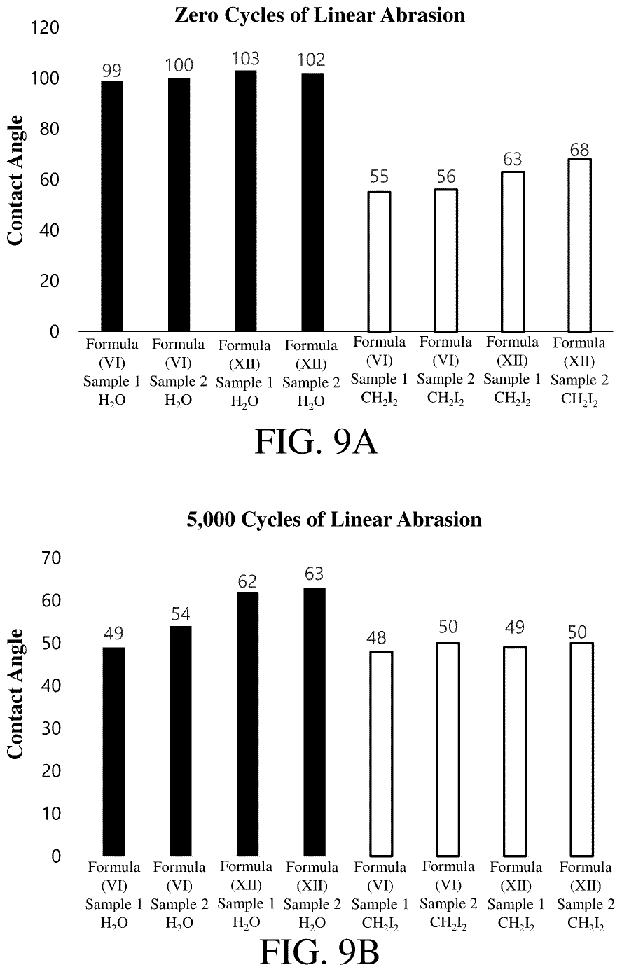

The linear abrasion was repeated up to 5,000 cycles. The water contact angles and diiodomethane contact angles of the abraded area of each article were measured. See FIGS. 9A-9B.

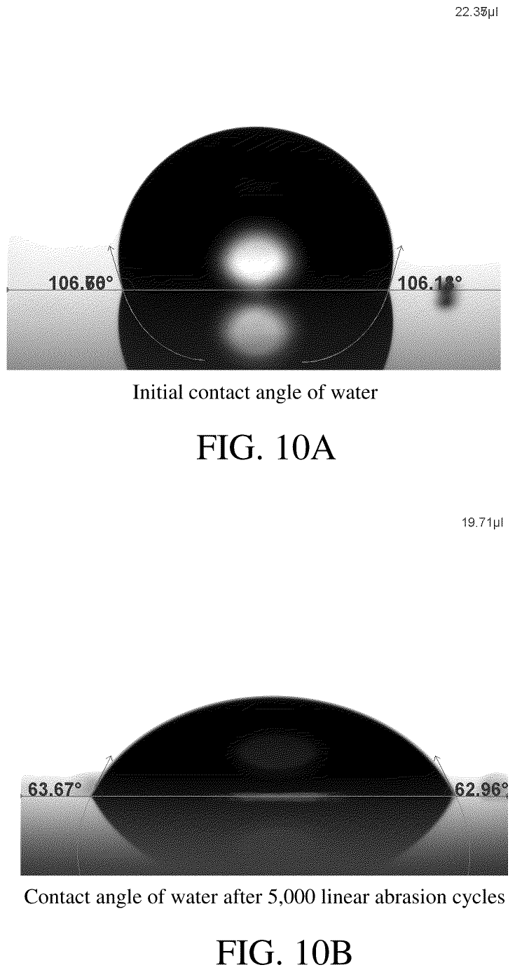

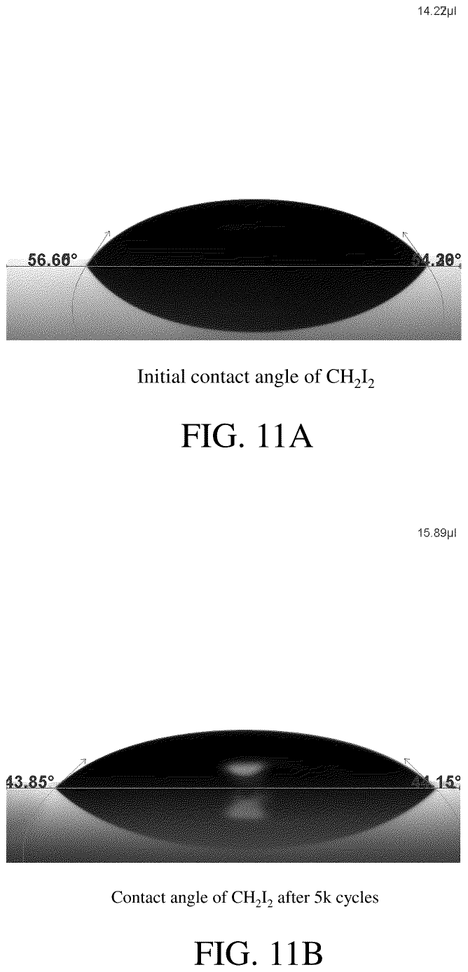

Snapshots of the water contact angle before and after 5,000 linear abrasion cycles for a silane compound shown in Formula (XII) are shown in FIGS. 10A-10B. Snapshots of the diiodomethane contact angle before and after 5,000 linear abrasions cycles for a silane compound shown in Formula (XII) are shown in FIGS. 11A-11B.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A composition, comprising:
a fingerprint inhibition material comprising a silane compound, the silane compound comprising a polysiloxane, wherein the fingerprint inhibition material is non-fluorinated, and
wherein a water contact angle of the composition is greater than or equal to 95°.

2. The composition of claim 1, wherein a molecular weight of the silane compound is greater than or equal to 500 Da and less than or equal to 50,000 Da.

3. The composition of claim 1, wherein the water contact angle of the composition is less than or equal to 180°.

4. The composition of claim 1, wherein the water contact angle decreases by less than or equal to 50% after 5,000 linear abrasion cycles.

5. The composition of claim 1, wherein the water contact angle decreases by less than or equal to 10% after 5,000 linear abrasion cycles.

6. The composition of claim 1, wherein a diiodomethane contact angle of the composition is between greater than or equal to 55° and less than or equal to 180°.

7. The composition of claim 6, wherein the diiodomethane contact angle decreases by less than or equal to 50% after 5,000 linear abrasion cycles.

8. The composition of claim 6, wherein the diiodomethane contact angle decreases by less than or equal to 10% after 5,000 linear abrasion cycles.

9. The composition of claim 1, wherein a coefficient of friction of the composition is less than or equal to 0.15.

10. The composition of claim 1, wherein a coefficient of friction of the composition is less than or equal to 0.1.

11. The composition of claim 1, wherein a coefficient of friction of the composition is less than or equal to 0.05.

12. The composition of claim 1, wherein a percent optical transmittance of the coating is greater than or equal to 90%.

13. The composition of claim 1, wherein the silane compound comprises the structure: 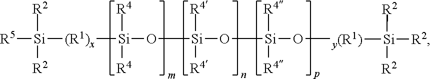
wherein:
each R¹ is the same of different and is selected from the group consisting of oxygen, —C₁-C₁₀ alkylene-, —C₂-C₁₀ alkenylene-, and —C₃-C₁₀ alkynylene-,
each R² is the same or different and is selected from the group consisting of hydrogen, deuterium, —C₁-C₁₀ alkyl, —C₂-C₁₀ alkenyl, —C₃-C₁₀ alkynyl, a halogen, and OR³,
each R³ is the same or different and is selected from the group consisting of hydrogen, deuterium, —C₁-C₁₀ alkyl, —C₂-C₁₀ alkenyl, —C₃-C₁₀ alkynyl, and —Si(R²)₃,
each R⁴, R^{4′}, and R^{4″} is the same or different and is selected from the group consisting of hydrogen, deuterium, —C₁-C₁₀ alkyl, —C₂-C₁₀ alkenyl, —C₃-C₁₀ alkynyl, OR³, —C₁-C₁₀ alkylene-Si(OR³)₃, —C₂-C₁₀ alkenylene-Si(OR³)₃, —C₃-C₁₀ alkynylene-Si(OR³)₃, —C₁-C₁₀ alkylene-(Si(OR³)₃)₂, —C₂-C₁₀ alkenylene-(Si(OR³)₃)₂, —C₃-C₁₀ alkynylene-(Si(OR³)₃)₂, —C₁-C₁₀ alkylene-Si(R²)₂—(R¹)—((R²)₂—Si—O)_{z}—Si(R²)₃, —C₂-C₁₀ alkenylene-Si(R²)₂—(R¹)—((R²)₂—Si—O)_{z}—Si(R²)₃, and —C₃-C₁₀ alkynylene-Si(R²)₂—(R¹)—((R²)₂—Si—O)_{z}—Si(R²)₃,
R⁵ is selected from the group consisting of R² and —R⁶—R⁷—R⁸, wherein R⁶ is selected from the group consisting of —C₁-C₁₀ alkylene-, —C₂-C₁₀ alkenylene-, and —C₃-C₁₀ alkynylene-, wherein R⁷ is selected from the group consisting of oxygen and sulfur, and wherein R⁸ is selected from the group consisting of —C₁₀-C₂₀ alkylene-Si(OR³)₃, —C₁₀-C₂₀ alkenylene-Si(OR³)₃, and —C₁₀-C₂₀ alkynylene-Si(OR³)₃,
x and y are independently 0 or 1,
z is greater than or equal to 1, and
m, n, and/or p are 0 or greater with the proviso that at least one of m, n, or p is greater than or equal to 2.

14. The composition of claim 13, wherein m is greater than or equal to 0 and less than or equal to 1000.

15. The composition of claim 13, wherein m is greater than or equal to 10 and less than or equal to 400.

16. The composition of claim 13, wherein n is greater than or equal to 0 and less than or equal to 1000.

17. The composition of claim 13, wherein n is greater than or equal to 10 and less than or equal to 400.

18. The composition of claim 13, wherein p is greater than or equal to 0 and less than or equal to 1000.

19. The composition of claim 13, wherein p is greater than or equal to 10 and less than or equal to 400.

20. The composition of claim 13, wherein the polysiloxane comprises polydimethylsiloxane and/or a silicon-hydride.

21. The composition of claim 13, wherein the polysiloxane comprises polydimethylsiloxane.

22. The composition of claim 1, wherein the silane compound comprises the structure: 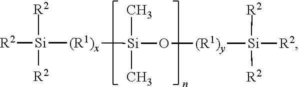
wherein:
each R¹ is the same of different and is selected from the group consisting of oxygen, —C₁-C₁₀ alkylene-, —C₂-C₁₀ alkenylene-, and —C₃-C₁₀ alkynylene-,
each R² is the same or different and is selected from the group consisting of hydrogen, deuterium, —C₁-C₁₀ alkyl, —C₂-C₁₀ alkenyl, —C₃-C₁₀ alkynyl, a halogen, and OR³,
each R³ is the same or different and is selected from the group consisting of hydrogen, deuterium, —C₁-C₁₀ alkyl, —C₂-C₁₀ alkenyl, and —C₃-C₁₀ alkynyl,
x and y are independently 0 or 1, and
n is greater than or equal to 2.

23. The composition of claim 1, wherein the polysiloxane comprises a silicon-hydride.

24. The composition of claim 1, wherein the polysiloxane comprises polydimethylsiloxane and a silicon-hydride.

25. The composition of claim 1, wherein R⁵ is —R⁶—R⁷—R⁸, wherein R⁶ is selected from the group consisting of —C₁-C₁₀ alkylene-, —C₂-C₁₀ alkenylene-, and —C₃-C₁₀ alkynylene-, wherein R⁷ is selected from the group consisting of oxygen and sulfur, wherein R⁸ is selected from the group consisting of —C₁₀-C₂₀ alkylene-Si(OR³)₃, —C₁₀-C₂₀ alkenylene-Si(OR³)₃, and —C₁₀-C₂₀ alkynylene-Si(OR³)₃, and wherein R³ is the same or different and is selected from the group consisting of hydrogen, deuterium, —C₁-C₁₀ alkyl, —C₂-C₁₀ alkenyl, and —C₃-C₁₀ alkynyl.

26. The composition of claim 25, wherein R⁶ is —C₁-C₁₀ alkylene-, wherein R⁸ is —C₁₀-C₂₀ alkylene-Si(OR³)₃, and wherein R³ is the same or different and is selected from the group consisting of hydrogen, deuterium, —C₁-C₁₀ alkyl, —C₂-C₁₀ alkenyl, and —C₃-C₁₀ alkynyl.

27. The composition of claim 25, wherein R⁶ is —(CH₂)₂—, wherein R⁸ is —(CH₂)₁₁—Si(OR³)₃, and wherein each R³ is the same or different and is selected from the group consisting of hydrogen and —C₁-C₁₀ alkyl.

28. The composition of claim 25, wherein R⁶ is —(CH₂)₂—, wherein R⁷ is sulfur, wherein R⁸ is —(CH₂)₁₁—Si(OR³)₃, and wherein each R³ is the same or different and is selected from the group consisting of hydrogen and —C₁-C₁₀ alkyl.

29. The composition of claim 1, wherein the silane compound comprises the structure: 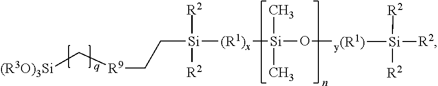
wherein:
each R¹ is the same of different and is selected from the group consisting of oxygen, —C₁-C₁₀ alkylene-, —C₂-C₁₀ alkenylene-, and —C₃-C₁₀ alkynylene-,
each R² is the same or different and is selected from the group consisting of hydrogen, deuterium, —C₁-C₁₀ alkyl, —C₂-C₁₀ alkenyl, —C₃-C₁₀ alkynyl, a halogen, and OR³,
each R³ is the same or different and is selected from the group consisting of hydrogen, deuterium, —C₁-C₁₀ alkyl, —C₂-C₁₀ alkenyl, and —C₃-C₁₀ alkynyl,
R⁹ is selected from the group consisting of oxygen and sulfur,
x and y are independently 0 or 1,
n is greater than or equal to 2, and
q is greater than or equal to 10 and less than or equal to 20.

30. The composition of claim 1, further comprising one or more adhesion promoters.

31. The composition of claim 30, wherein the one or more adhesion promoters comprise tetraethylorthosilicate and/or 1,2-bis(triethoxysilyl)ethane.
